(19) United States
(12) Patent Application Publication
(10) Pub. No.: US 2001/0037305 A1
(43) Pub. Date: Nov. 1, 2001

(54) Interactive navigation system

(76) Inventor: Yoshiyuki Mochizuki, Suita (JP)

Correspondence Address: WENDEROTH, LIND & PONACK, L.L.P., 2033 K STREET N. W., SUITE 800, WASHINGTON, DC, 20006-1021, US

(21) Appl. No.: 09/842,181

(22) Filed: Apr. 26, 2001

(30) Foreign Application Priority Data
Apr. 28, 2000 (JP) 2000-129105

(51) Int. Cl. G06F 17/60; G01C 21/26

(52) U.S. Cl. 705/52; 701/201

(57) ABSTRACT

In an interactive navigations system, when a server transmits map data to a mobile apparatus, an appropriate amount of charge is billed to the mobile apparatus. Also at route search, an optimal route is found more accurately.

A map data selector 105 selects, from among map data stored in a map data storage 106, only map data including a route found by a route search part 104. A billing part 103 refers to a price list including unit prices for the map data, and calculates the amount of charge for the map data selected by the map data selector 105. The route search part 104 searches for a route according to a route graph with a weight added to each link. The weight is calculated based on the number of non-target mobile apparatuses 52a that will presumably pass through each link simultaneously when a target mobile apparatus 52a will pass through the link.

### BACKGROUND OF THE INVENTION

1. Field of the Invention

The present invention relates to navigation systems and, more specifically, to an interactive navigation system that comprises a mobile apparatus and a server, and carries out navigation by the mobile apparatus requesting the server to search for a route and the server sending a search result to the mobile apparatus.

2. Description of the Background Art

Non-interactive navigation device

Non-interactive navigation devices that have been conventionally used are exemplarily structured as shown in FIG. 18, which is disclosed in Japanese Patent Laid-Open Publication No. 5-216399 (1993-216339). In FIG. 18, a conventional non-interactive navigation device includes a map data storage 301, a vehicle position detector 302, a display part 303, a map scale selection switch 304, a map scale controller 305, a display controller, and a route search part 307.

In the above-structured navigation device, the map data storage 301 stores map data. The vehicle position detector 302 detects the present position of a vehicle that mounts the navigation device thereon. The route search part 307 retrieves required map data from the map data storage 301 based on the present position detected by the vehicle position detector 302 (or, a starting point specified by a user) and a destination specified by the user, and searches for an optimum route. The display controller 306 causes the display part 303 to display at least the present position of the vehicle and the optimum route on a map.

The user can use the map scale selection switch 304 for selecting the scale of the displayed map. Based on the selection, the map scale controller 305 instructs the display controller 306 to access the map data of the selected scale. In response, the display controller 306 retrieves the map data of that scale from the map data storage 301. The display part 303 then displays a map based on the map data and overlays the present position of the vehicle on the map.

In the above non-interactive navigation device, a removable storage medium such as a CD-ROM or DVD is generally used as the map data storage 301. By replacing the entire medium with another, the map data can be updated. However, the map data is usually updated once or twice a year, and therefore cannot instantly reflect new events, such as the streets are closed due to maintenance, or a new road is open. The difference between the map data and the actual situations of the roads often disables appropriate navigation.

Conventional interactive navigation system

To avoid the above problem, recently suggested are interactive navigation systems comprising a mobile apparatus and a server. Navigation is carried out by the mobile apparatus requesting the server to search for a route and the server sending a search result to the mobile apparatus. In such newly suggested interactive navigation system, the server manages the map data. Therefore, the map data can instantly reflect road maintenance, the opening of a road, and other events, thereby enabling navigation with the actual road situations reflected thereon.

Conventional route search method; Dijkstra's algorithm

In the above non-interactive navigation device, the route search part 307 searches for the optimum route with the Dijkstra's algorithm, which is now described below.

FIG. 19 is a diagram demonstrating optimum-route search with the Dijkstra's algorithm. This optimum-route search is generally performed based on a route graph composed of nodes and links as shown in FIG. 19. A node corresponds to an intersection, and a link corresponds to a section between the nodes on a road.

In the route graph of FIG. 19, a numerical value is assigned to each link. This value is called a link length. The link length represents, for example, the length of the section of the road, or time when the vehicle passes that section through at legal speed. In the drawing, several routes can be thought from a point S to a point T. Of these routes, a route where the total number of link lengths composing that route is minimum is the optimum route.

Therefore, the route search part 307 finds a route where the total number of link lengths composing that route is minimum as the optimum route from among a plurality of routes from the starting point (present position) to the destination.

In this method, however, the optimum route is found based on the time required when the vehicle travels at the predetermined speed, that is, based on a fixed value. Therefore, it happens quite often that the vehicle runs into a traffic jam and arrives late.

Route search method in consideration of traffic jam; the Dijkstra's algorithm with weighting

To get around the problem, also suggested are navigation devices carrying out optimum-route search in consideration of traffic jam. Traffic jam information is externally provided by, for example, VICS (Vehicle Information and Communication System) (see “automobile traffic system for the 21st century”, Sadao Takaba, Kogyo Chosakai Publishing Co., Ltd., pp. 95-97, 1998).

Route search in consideration of traffic jam is performed by the Dijkstra's algorithm with weighting. FIG. 20 is a diagram demonstrating optimum-route search by the Dijkstra's algorithm with weighting. In a route graph shown in FIG. 20, several links are provided with a weight “aij” onto the previously assigned link length. If the link length represents time required when the vehicle passes through the link, the weight “aij” to be provided to the link length represents time in proportion to a degree of traffic jam. With such weight provided to the link, the time required for actually traveling the road section can be represented more correctly.

Such route search by using the route graph with weighting can find an optimum route more accurately compared with the one without weighting. The optimum route is a route the vehicle can travel in a minimum period of time. If following the route found with this method, the vehicle will less happen to run into a traffic jam and arrive late.

Problem in the interactive navigation system

In the interactive navigation system, the server carries out route search, and then not only transmits the search results to the mobile apparatus but may also transmits thereto various map data, information related to the map data (traffic jam, attractions, and events, for example). If transmitting the map data and related information to the mobile apparatus, the server has to bill a user of the mobile apparatus at an appropriate amount of charge. However, no billing method for this case has not been known.

Therefore, a first object of the present invention is to provide a method of billing a mobile apparatus for provided map data and relate information at an appropriate charge, and an interactive navigation system that carries out such billing.

Problem in the route search method in consideration of traffic jam

The externally provided traffic jam information only indicates the situations of traffic jam at one previous time. When the vehicle actually travels the road, the situations of traffic jam may possibly be different from those indicated by the traffic jam information. In other words, the route search in consideration of the externally provided traffic jam information only finds an optimum route at one previous time. Therefore, it may still happen that the vehicle runs into a traffic jam and arrives late.

Therefore, a second object of the present invention is to provide a navigation system that can more accurately finds an optimum route when the vehicle actually travels a road and, as a result more prevents a vehicle from running into a traffic jam and arriving late.

### SUMMARY OF THE INVENTION

The present invention has the following features to achieve the objects above.

A first aspect of the present invention is directed to an interactive navigation system that comprises a mobile apparatus and a server and carries out navigation by the mobile apparatus requesting the server to search for a route and the server transmitting a search result to the mobile apparatus, the mobile apparatus comprising:

an input part for inputting at least a destination; and

a first transmitter for transmitting a packet including at least the destination inputted by the input part to the server,

the server comprising:

a map data storage for storing map data;

a first receiver for receiving the packet transmitted by the first transmitter;

a route search part for searching for the route based on the destination included in the packet received by the first receiver and the map data stored in the map data storage;

a map data selector for selecting, from among the map data stored in the map data storage, only map data including the route found by the route search part;

a billing part that holds a price list (FIG. 7 including unit prices for the map data stored in the map data storage, for calculating an amount of charge for the map data selected by the map data selector based on the price list, and generating billing information including at least the amount of charge; and

a second transmitter for transmitting, to the mobile apparatus, a packet including at least the route found by the route search part, the map data selected by the map data selector, and the billing information generated by the billing part.

In the first aspect (or tenth to twelfth aspects described below), the mobile apparatus transmits a packet including at least a destination inputted by user to the server. The server receives the packet.

The server stores map data, and carries out route search based on the destination included in the received packet and the stored map data. Then, the server selects, from among the stored map data, only the map data including the route found by the route search part.

The server also holds a price list including unit prices for the map data stored in the map data storage. Such unit prices include a price per sheet of map and price per unit amount of information. Based on the price list, the server calculates the amount of charge for the selected map data, and generating billing information including at least the amount of charge. Then, the server transmits a packet including at least the found route, the selected map data, and the generated billing information to the mobile apparatus.

Thus, it is possible to bill the user of the mobile apparatus at the charge (in proportion to the number of sheets or the data amount, for example) based on the map data transmitted to the mobile apparatus.

In addition, the length of the route found by search varies for each search. For example. a route from Osaka to Kobe is entirely different in length from that from Osaka to Fukuoka. Moreover, several routes can be thought from one starting point to one destination, and they vary in length. Therefore, the number of sheets of maps based on the map data and the amount of map data vary according to the route taken.

Therefore, in the first aspect, a route search is carried out in response to a request from the mobile apparatus, and map data including the route found by search is selected, and the amount of charge according to the number of sheets of map and the amount of data is billed to the mobile apparatus. In this case, the user of the mobile apparatus pays only for the map data transmitted thereto.

According to a second aspect, in the first aspect, the mobile apparatus further comprises:

a second receiver for receiving the packet transmitted by the second transmitter; and

a route guide part for carrying out route guide based on the route included in the packet received by the second receiver and the map data.

In the second aspect, the mobile apparatus receives the packet transmitted by the server. Then, the mobile apparatus carries out route guide based on the route included in the received packet and the map data.

According to a third aspect, in the first aspect, the mobile apparatus further comprises a present position detector for detecting a present position of the mobile apparatus,

the packet transmitted by the first transmitter further includes the present position detected by the present position detector, and

based on the present position and the destination included in the packet received by the first receiver and the map data stored in the map data storage, the route search part searches for the route from the present position and the destination.

In the third aspect, the mobile apparatus detects its present position, and transmits a packet including the detected present position. The server searches for a route from the present position and the destination based on the present position and destination included in the received packet and the stored map data.

According to a fourth aspect, in the first aspect,

a starting point is inputted by the input part,

the packet transmitted by the first transmitter includes the starting point inputted by the input part, and

based on the starting point and the destination included in the packet received by the first receiver and the map data stored in the map data storage, the route search part searches for the route from the starting point and the destination.

In the fourth aspect, the mobile apparatus transmits a packet including the destination inputted by the user to the server. The server searches for a route from the starting point to the destination based on the starting point and destination included in the received packet and the stored map data.

According to a fifth aspect, in the first aspect,

the server further comprises a related information storage for storing related information relating to the map data stored in the map data storage,

the price list held by the billing part includes a unit price for the related information stored in the related information storage,

the billing part calculates an amount of charge for related information relating to the map data selected by the map data selector, and adds the calculated amount of charge to the billing information, and

the packet transmitted by the second transmitter further includes the related information relating to the map data selected by the map data selector.

Thus, it is possible to bill the user of the mobile apparatus at the charge (in proportion to the number of areas or the data amount, for example) based on the related information transmitted to the mobile apparatus.

Here, as described above, the route found by search varies for each search. Therefore, the number of sheets of map and the amount of data required for route guide vary according to the route taken, and the information related to the map data varies accordingly.

Therefore, in the fifth aspect, a route search is carried out in response to a request from the mobile apparatus, and map data including the route found by search is selected. Then, the amount of charge for the map data according to the number of sheets of map and the amount of data and the amount of charge for the related information according to the number of areas and the amount of data is billed to the mobile apparatus. In this case, the user of the mobile apparatus pays only for the map data and related information transmitted thereto.

According to a sixth aspect, in the fifth aspect,

the mobile apparatus further comprises a presenter for presenting the related information included in the packet received by the second receiver.

In the sixth aspect, the related information included in the received packet is presented. For example, the related information includes, as in the following seventh aspect, traffic jam information as to the roads in the area corresponding to the map data. Alternatively, the related information may include events and discount sales held in that corresponding area, or sightseeing spots therein. Presentation of the related information is performed through a display and/or a speaker.

According to a seventh aspect, in the sixth aspect, the related information includes traffic jam information for roads in an area that corresponds to the map data, and

the billing part calculates an amount of charge for the traffic jam information as the amount of charge for related information relating to the map data selected by the map data selector.

In the seventh aspect, when the related information includes traffic jam information, the server calculates, as the amount of charge for the information related to the selected map data, the amount of charge for the traffic jam information as to the roads in the area corresponding to the map data. For example, if selecting data for two sheets of map, the server calculates the amount of charge for the traffic information as to the roads in the areas corresponding to these two sheets of map, and adds the amount of charge to the billing information. Then, the server transmits the traffic information for the two areas together with the map data for two sheets of map.

According to an eighth aspect, in the first aspect,

a registration identifier is further inputted by the input part,

the packet transmitted by the first transmitter further includes the registration identifier inputted by the input part,

the server further comprises a registration check part that holds a registration check list including at least all valid registration identifiers, for determining whether the registration identifier included in the packet received by the first receiver is in the registration check list, and

the route search part carries out the route search only when the registration check part determines that the registration identifier is in the registration check list.

In the eighth aspect, unregistered members cannot use the system without paying the charge.

According to a ninth aspect, in the first aspect,

the map data storage stores a plurality of map data of different forms for use in displaying a same map,

a registered data form is further inputted by the input part,

the packet transmitted by the first transmitter further includes the registered data form inputted by the input part,

the registration check list held by the registration check part includes the registered data form that corresponds to a registered identifier, and

the map data selector selects, from among the map data stored in the map data storage, only map data including the route found by the route search part and complying with a registered data form included in the packet received by the first receiver.

In the ninth aspect, the mobile apparatuses varying in map data form can be each provided with the map data of each appropriate form.

A tenth aspect of the present invention is directed to a server that searches for a route in response to a request from a mobile apparatus and transmits the route found by search to the mobile apparatus,

the mobile apparatus comprising:

an input part for inputting at least a destination; and

a first transmitter for transmitting a packet including at least the destination inputted by the input part to the server,

the server comprising:

a map data storage part for storing map data;

a first receiver for receiving the packet transmitted by the first transmitter;

a route search part for searching for the route based on the destination included in the packet received by the first receiver and the map data stored in the map data storage;

a map data selector for selecting, from among the map data stored in the map data storage, only map data including the route found by the route search part;

a billing part that holds a price list including unit prices for the map data stored in the map data storage, for calculating an amount of charge for the map data selected by the map data selector based on the price list, and generating billing information including at least the amount of charge; and

a second transmitter for transmitting, to the mobile apparatus, a packet including at least the route found by the route search part, the map data selected by the map data selector, and the billing information generated by the billing part.

An eleventh aspect of the present invention is directed to an interactive navigation method of carrying out navigation by searching for a route in response to a request from a mobile apparatus and transmitting the route found to the mobile apparatus,

the mobile apparatus comprising:

an input part for inputting at least a destination; and

a transmitter for transmitting a packet including at least the destination inputted by the input part to the server,

the method comprising:

a step of storing map data;

a step of receiving the packet transmitted by the transmitter;

a step of searching for the route based on the destination included in the packet received in the receiving step and the map data stored in the map data storing step;

a step of selecting, from among the map data stored in the map data storing step, only map data including the route found in the route searching step;

a billing step of calculating an amount of charge for the map data selected in the map data selecting step based on a price list including unit prices for the map data stored in the map data storing step, and generating billing information including at least the amount of charge; and

a step of transmitting, to the mobile apparatus, a packet including at least the route found in the route searching step, the map data selected in the map data selecting step, and the billing information generated in the billing step.

A twelfth aspect of the present invention is directed to a program that describes an interactive navigation method of carrying out navigation by searching for a route in response to a request from a mobile apparatus and transmitting the route found to the mobile apparatus,

the mobile apparatus comprising:

an input part for inputting at least a destination; and

a transmitter for transmitting a packet including at least the destination inputted by the input part to the server,

the method comprising:

a step of storing map data;

a step of receiving the packet transmitted by the transmitter;

a step of searching for the route based on the destination included in the packet received in the receiving step and the map data stored in the map data storing step;

a step of selecting, from among the map data stored in the map data storing step, only map data including the route found in the route searching step;

a billing step of calculating an amount of charge for the map data selected in the map data selecting step based on a price list including unit prices for the map data stored in the map data storing step, and generating billing information (FIG. 8) including at least the amount of charge; and

a step of transmitting, to the mobile apparatus, a packet including at least the route found in the route searching step, the map data selected in the map data selecting step, and the billing information generated in the billing step.

A thirteenth aspect of the present invention is directed to an interactive navigation system that comprises a plurality of mobile apparatuses and a server and carries out navigation by one of the mobile apparatuses requesting the server to search for a route and the server transmitting a search result to the mobile apparatus,

each of the mobile apparatuses comprising:

an input part for inputting at least a destination;

a present position detector for detecting a present position of the mobile apparatus; and

a first transmitter for transmitting a packet including at least the destination inputted by the input part and/or the present position detected by the present position detector to the server,

the server comprising:

a map data storage for storing map data;

a first receiver for receiving the packet transmitted by the first transmitter;

a route search part for searching for a route, if the packet received by the first receiver includes the destination, based on the destination and the map data stored in the map data storage; and

a second transmitter for transmitting a packet including at least the route found by the route search part to the mobile apparatus, wherein

the route search part

holds a mobile apparatus position/route management table for recording and managing the present position of each of the mobile apparatuses and the route found for each of the mobile apparatuses,

finds a plurality of reachable routes to the destination when the packet received by the first receiver includes the destination,

sequentially calculates, for each of the found reachable routes, a time when a target mobile apparatus will pass at predetermined speed along the route through each link composing the reachable route,

calculates, for each link, a number of presumed passing apparatuses that indicates how many mobile apparatuses will pass through the link simultaneously when the target mobile apparatus will pass through the link, based on the present position of the mobile apparatuses other than the target mobile apparatus and the route recorded in the mobile apparatus position/route management table,

calculates a weight to be provided to each link based on the number of presumed passing apparatuses calculated for each link , and

searches for the route based on a route graph with each link provided with at least the weight calculated based on the number of presumed passing apparatuses.

In the thirteenth aspect (or fifteenth and sixteenth aspects described below), the server holds a mobile apparatus position/route management table for recording and managing the present position of each of the mobile apparatuses and the route found for each of the mobile apparatuses.

The mobile apparatus for search (hereinafter, target mobile apparatus) transmits a packet including at least the destination to the server. The other mobile apparatuses (hereinafter, non-target mobile apparatus) each detect its own present position, and transmit a packet including at least the detected present position to the server in predetermined timing (several times per second periodically, for example).

The server stores the map data, and receives the packet transmitted by the mobile apparatus. If the received packet includes the destination, the server carries out a route search based on the destination and the stored map data. Then, the server transmits a packet including at least the route found by search to the destination.

At route search, the sever first finds plurality of reachable routes. Then, the server sequentially calculates, for each of the found reachable routes, a time when a target mobile apparatus will pass at predetermined speed along the route through each link composing the reachable route. Then, the server calculates, for each link, a number of presumed passing apparatuses that indicates how many non-mobile apparatuses will pass through the link simultaneously when the target mobile apparatus will pass through the link, based on the present position of the non-target mobile apparatuses and the route recorded in the mobile apparatus position/route management table. Then, the server calculates a weight to be provided to each link based on the number of presumed passing apparatuses calculated for each link. Then, the server searches for the route based on a route graph with each link provided with at least the weight calculated based on the number of presumed passing apparatuses.

As such, a route search is carried out by using a route graph with each link provided with a weight calculated based on the number of presumed passing apparatuses for the road section (link) when the target mobile apparatus actually will pass through the road section. Therefore, compared with a route search using a route graph based on only the traffic jam at previous time, the optimum route when the mobile apparatus actually passes the road section is found more accurately.

According to a fourteenth aspect, in the thirteenth aspect,

the server further comprises an input/output part connected to a communication line network, and the route search part

further externally receives traffic jam information through the input/output part and the communication line network, and calculates a weight to be provided to each link based on the traffic jam information,

finds the plurality of reachable routes based on a route graph with each link provided with the weight calculated based on the traffic jam information, and

searches for the route based on the weight calculated based on the traffic jam information and the weight calculated based on the number of presumed passing apparatuses.

In the fourteenth aspect, a route search is carried out by using a route graph with each link provided with a weight based on the traffic jam at previous time and a weight calculated based on the number of presumed passing apparatuses for the road section when the target mobile apparatus actually will pass through the road section. Therefore, the optimum route is found more accurately.

A fifteenth aspect of the present invention is directed to an interactive navigation method of carrying out navigation by searching for a route in response to a request from one of a plurality of mobile apparatuses and transmitting the route found to the mobile apparatus,

each of the mobile apparatuses comprising:

an input part for inputting at least a destination;

a present position detector for detecting a present position of the mobile apparatus; and

a transmitter for transmitting a packet including at least the destination inputted by the input part and/or the present position detected by the present position detector to the server,

the method comprising:

a step of storing map data;

a step of receiving the packet transmitted by the transmitter;

a step of searching for a route, when the packet received in the receiving step includes the destination, based on the destination and the map data stored in the map data storing step; and

a step of transmitting a packet including at least the route found in the route searching step to the mobile apparatus,

in the route searching step,

a mobile apparatus position/route management table is held for recording and managing the present position of each of the mobile apparatuses and the route found for each of the mobile apparatuses, and

the route searching step further comprising:

a step of finding a plurality of reachable routes to the destination if the packet received in the receiving step includes the destination;

a step of sequentially calculating, for each of the found reachable routes, a time when a target mobile apparatus will pass at predetermined speed along the route through each link composing the reachable route;

a step of calculating, for each link, a number of presumed passing apparatuses that indicates how many mobile apparatuses will pass through the link simultaneously when the target mobile apparatus will pass through the link, based on the present position of the mobile apparatuses other than the target mobile apparatus and the route recorded in the mobile apparatus position/route management table;

a step of calculating a weight to be provided to each link based on the number of presumed passing apparatuses calculated for each link; and

a step of searching for the route based on a route graph with each link provided with at least the weight calculated based on the number of presumed passing apparatuses.

A sixteenth aspect of the present invention is directed to a program that describes an interactive navigation method of carrying out navigation by searching for a route in response to a request from one of a plurality of mobile apparatuses and transmitting the route found to the mobile apparatus,

each of the mobile apparatuses comprising:

an input part for inputting at least a destination;

a present position detector for detecting a present position of the mobile apparatus; and

a transmitter for transmitting a packet including at least the destination inputted by the input part and/or the present position detected by the present position detector to the server,

the method comprising:

a step of storing map data;

a step of receiving the packet transmitted by the transmitter;

a step of searching for a route, when the packet received in the receiving step includes the destination, based on the destination and the map data stored in the map data storing step; and

a step of transmitting a packet including at least the route found in the route searching step to the mobile apparatus, wherein

in the route searching step,

a mobile apparatus position/route management table is held for recording and managing the present position of each of the mobile apparatuses and the route found for each of the mobile apparatuses, and

the route searching step further comprising:

a step of finding a plurality of reachable routes to the destination if the packet received in the receiving step includes the destination;

a step of sequentially calculating, for each of the found reachable routes, a time when a target mobile apparatus will pass at predetermined speed along the route through each link composing the reachable route;

a step of calculating, for each link, a number of presumed passing apparatuses that indicates how many mobile apparatuses will pass through the link simultaneously when the target mobile apparatus will pass through the link, based on the present position of the mobile apparatuses other than the target mobile apparatus and the route recorded in the mobile apparatus position/route management table;

a step of calculating a weight to be provided to each link based on the number of presumed passing apparatuses calculated for each link; and

a step of searching for the route based on a route graph with each link provided with at least the weight calculated based on the number of presumed passing apparatuses.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the structure of a interactive navigation system according to a first embodiment of the present invention;

FIG. 2A is a block diagram showing the hardware structure of a server in the interactive navigation system according to the first embodiment of the present invention;

FIG. 2B is a block diagram showing the hardware structure of a mobile apparatus 52 in the interactive navigation system according to the first embodiment of the present invention;

FIG. 3A is a flowchart showing the operation of a mobile apparatus 52 in the interactive navigation system according to the first embodiment of the present invention;

FIG. 3B is a flowchart showing the operation of a server 51 in the interactive navigation system according to the first embodiment of the present invention;

FIG. 4 is a diagram showing the structure of a packet transmitted from the wireless transmitter/receiver 3 of the mobile apparatus 52 to the server 51;

FIG. 5 is a diagram showing a registration check list held by a registration check part 102;

FIG. 6 is a diagram exemplarily showing wide-area and detailed map data selectively read by a map data selector 105.

FIG. 7A is a diagram showing one example of a price list stored in a billing part 103, the list including unit prices of the map data per sheet;

FIG. 7B is a diagram showing another example of the price list including unit price of related information;

FIG. 8A is a diagram showing one example of an amount of charge (billing information) calculated based on the price list of FIG. 7A;

FIG. 8B is a diagram showing another example of the amount of charge (billing information ) calculated based on the price list of FIG. 7B;

FIG. 9 is a diagram showing the structure of a packet transmitted from a wireless transmitter/receiver 101 of the server 51 to the mobile apparatus 52;

FIG. 10 is a block diagram showing the structure of an interactive navigation system according to a second embodiment of the present invention;

FIG. 11 is a block diagram showing the structure of an interactive navigation system according to a third embodiment of the present invention;

FIG. 12A is a flowchart showing the operation of a mobile apparatus 52a in the interactive navigation system according to the third embodiment of the present invention;

FIG. 12B is a flowchart showing the operation of a server 51a in the interactive navigation system according to the third embodiment of the present invention;

FIG. 13 is a diagram showing the structure of a packet transmitted from a wireless transmitter/receiver 101 of the server 51a to the mobile apparatus 52a when billing is not handled;

FIG. 14 is a diagram showing a table held by a mobile apparatus position/route managing part 112;

FIG. 15 is a flowchart showing one detailed example of step S106a, wherein a route search part 104 searches for an optimum route, shown in FIG. 12B;

FIG. 16 is a diagram demonstrating an optimum route search by the Dijkstra's algorithm using first and second weights, wherein the second weight “bij” is unique to the present invention;

FIG. 17 is a block diagram showing the structure of an interactive navigation system according to a fourth embodiment of the present invention;

FIG. 18 is a block diagram showing one example of structure of a non-interactive navigation system;

FIG. 19 is a diagram demonstrating an optimum route search by the Dijkstra's algorithm; and

FIG. 20 is a diagram demonstrating an optimum route search by the Dijkstra's algorithm using a weight.

### DESCRIPTION OF THE PREFERRED EMBODIMENTS

(First embodiment)

Hereinafter, an interactive navigation system according to a first embodiment is described with reference to the drawings.

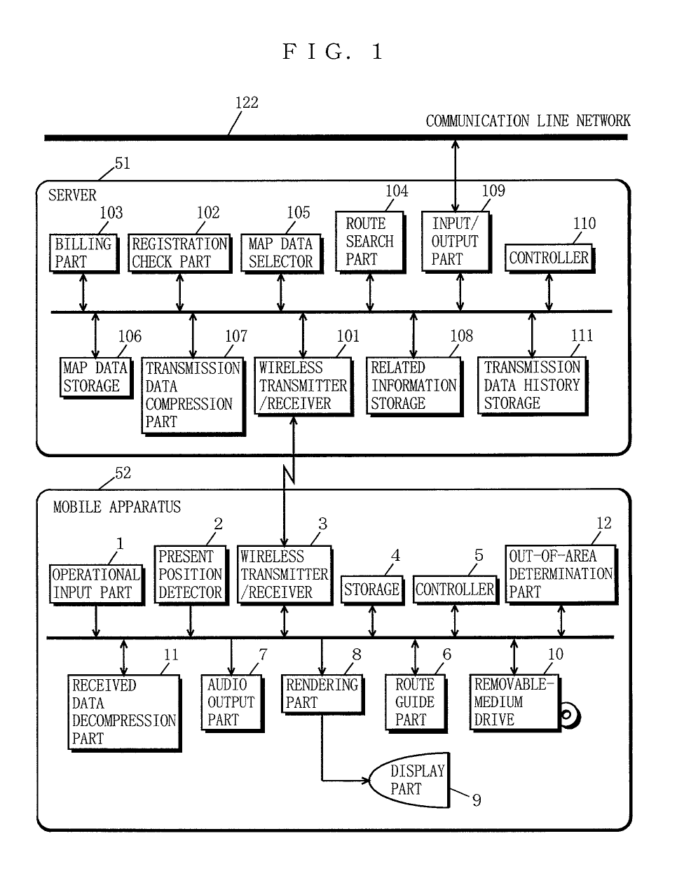

FIG. 1 is a block diagram showing the structure of the interactive navigation system according to the first embodiment of the present invention. In FIG. 1, the system includes a server 51 and a mobile apparatus 52. The mobile apparatus 51 includes an operational input part 1, a present position detector 2, a wireless transmitter/receiver 3, a storage 4, a controller 5, route guide part 6, an audio output part 7, a rendering part 8, a display part 9, a removable-medium drive 10, a received data decompression part 11, and an out-of-area determination part 12.

The server 51 includes a wireless transmitter/receiver 101, a registration check part 102, a billing part 103, a route search part 104, a map data selector 105, a map data storage 106, a transmission data compression part 107, a related information storage 108, an input/output part 109, a controller 110, and a transmission data history storage 111.

The mobile apparatus 52 and the server 51 can wirelessly communicate with each other. The server 51 can communicate, through a communication line network 122, with the outside such as a host computer in a traffic control center or in a financial institution (not shown).

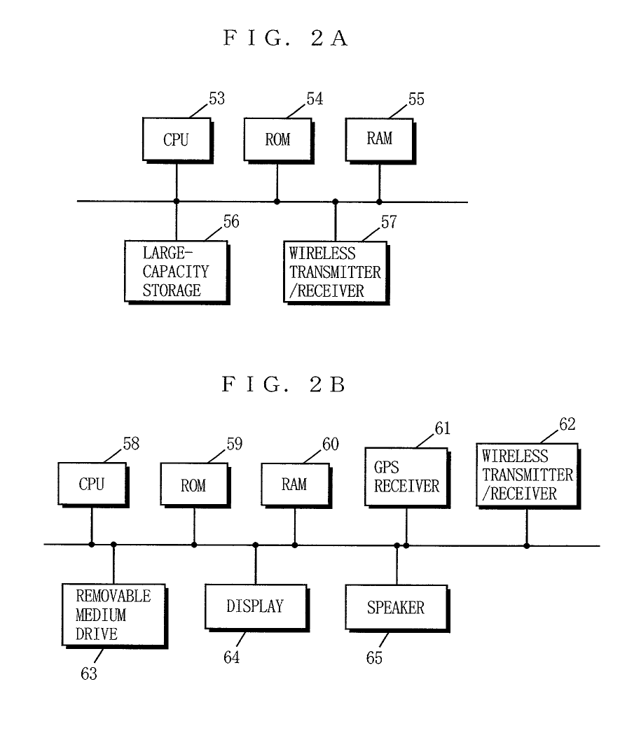

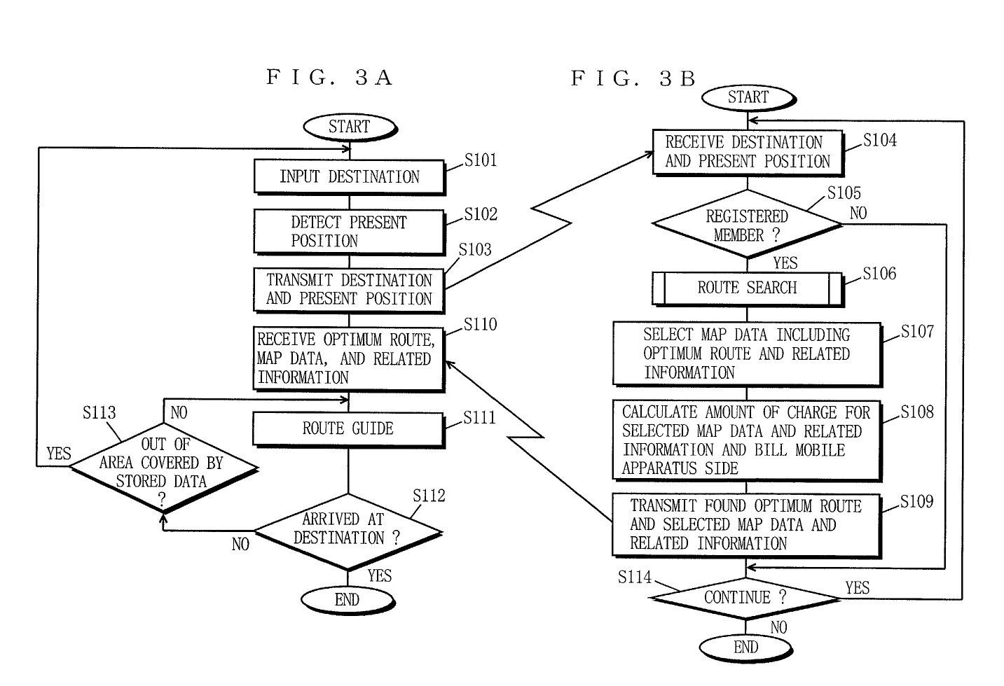

FIG. 2A is a block diagram showing one example of the hardware structure of the server 51, and FIG. 2B is a block diagram showing one example of the hardware structure of the mobile apparatus 52, both according to the present embodiment.

In FIG. 2A, the server 51 includes a CPU 53, ROM 54, RAM 55, a large-capacity storage 56, and a wireless transmitter/receiver 57. Stored in the ROM 54 is a program for the server 51. Following the program stored in the ROM 54, the CPU 53 operates by using the RAM 55 as a working area to perform operations and control other hardware, thereby realizing a function of each component shown in FIG. 1.

In FIG. 2B, the mobile apparatus 52 includes a CPU 58, ROM 59, RAM 60, a GPS receiver 61, a removable-medium drive 63 (CD-RW drive, for example) for a removable recording medium, a wireless transmitter/receiver 62 (cellular phone, for example), a display 64, a loudspeaker 65. Stored in the ROM 59 is a program for the mobile apparatus. Following the program stored in the ROM 59, the CPU 58 operates by using the RAM 60 as a working area to perform operations and control other hardware, thereby realizing a function of each component shown in FIG. 1.

The operation of the interactive navigation system according to the first embodiment of the present invention is briefly described.

FIG. 3A is a flowchart of the operation of the mobile apparatus 52, and FIG. 3B is a flowchart of the operation of the server 51, both according to the present embodiment. The operation of the mobile apparatus 52 shown in FIG. 3A is realized by the controller 5 carrying out operations and controlling other components (1 to 4, and 6 to 12). The operation of the server 51 shown in FIG. 3B is realized by the controller 110 carrying out operations and controlling other components (101 to 109, and 111 ).

In FIG. 3A, the mobile apparatus 52 receives an input concerning a destination provided by a user (step S101). The mobile apparatus 52 then detects the present position of a vehicle that mounts the mobile apparatus 52 thereon (step S102). The mobile apparatus 52 then provides the inputted destination and the detected present position to the server 51 side (step S103). To the present position and destination provided by the mobile apparatus 52, information for identifying a registered member or registered mobile apparatus 52 (hereinafter, registration identifier) is added. The mobile apparatus 52 then executes step S110, which will be described below.

In FIG. 3B, the server 51 receives the information provided by the mobile apparatus 52 in the above described manner (that is, destination and present position) (step S104). The server 51 stores a registration check table, checking a registration identifier added to the information against those in the table to determine whether the user is a registered member or not (step S105). If No, the procedure goes to step S114. Alternatively, before step S114, the server 51 may send a message that prompts the user for registration.

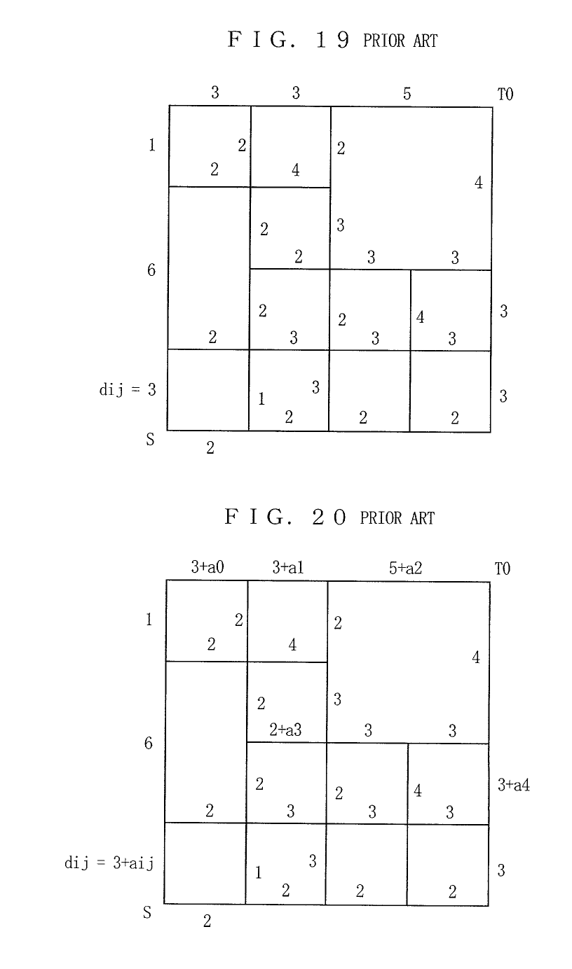

If Yes in step S105, the server searches for an optimal route from the present position to the destination (step S106). For this route search, the Dijkstra's algorithm as stated in Background Art section (refer to FIG. 19), the Dijkstra's algorithm using weights (refer to FIG. 20), and other algorithms are used.

The server 51 stores map data and its related information. The related information includes, for example, weather forecast, traffic jam information, the locations of parking lots and whether they have any vacancy, and various buildings and events. The server 51 selects, from the stored information, map data including the optimum route found in step S105 and its related information (step S107). Such map data includes, by way of example only, two type of map data, that is, wide-area map and detailed map around the route. The related information includes, also by way of example only, weather forecast and parking lot information around the area covered by the map data.

Next, the server 51 calculates the amount of and the charge for the information to be provided to the user of the mobile apparatus 52 (that is, the map data and related information selected in step S107), and bills the user (step S108). In response, the user electronically settles the bill by a credit card, debit card, or the like.

An issue of importance in this system is how to calculate the amount of charge in the billing process of the above step S108, which is summarized below.

In general, a different optimum route is found for each search in step S106. Different routes often have different amount and type of information selected in step S107. More specifically, the optimum route is found from the starting point (the present position of the mobile apparatus 52 detected in step S102) to the destination inputted in step S101. Based on the distance between the present position and destination inputted by the user, the route length varies, and the amount and type of information selected in step S107 usually varies accordingly. In general, different routes of the same length have different amounts and types of information selected.

Therefore, the server 52 calculates the amount of charge based on the information selected in step S107, that is, the information to be transmitted to the mobile apparatus 52. More specifically, the server 52 calculates the amount of charge based on the amount of information selected (on an as-used basis). More preferably, varying unit prices per unit amount of information are set for varying types of information, and the amount of charge is calculated based on the unit prices and the amount of information selected. By way of example only, the unit price is set for each sheet of the detailed map or for each Kbyte of the related information.

Electronic settlement is exemplarily carried out as follows. The server 51 is connected through the communication line network 122 to a host computer of a credit card company, bank, or any other financial institution, for notifying the host computer of the amount of charge. The host computer electronically manages the credit or account of the service provider and the user. Notified of the amount of charge, the host computer debits the amount of charge against the user's account, and credits that amount to the provider's account.

This is how to calculate the amount of charge in the billing process in step S108.

After the billing process in step S108 is completed, the server 51 transmits the information selected in step S107 to the mobile apparatus 52 (step S109). The server 51 then executes step S144, which will be described below.

In FIG. 3A, the mobile apparatus 52 receives the information transmitted from the server 51 in the above described manner (step S110). The information includes the optimum route, the map data covering the optimum route, and the related information. The mobile apparatus 51 guides the vehicle along the optimum route (step S111). In route guide, a symbol indicating the present position of the vehicle and the optimum route are overlaid on the map. The related information is also overlaid thereon, as required.

The mobile apparatus 51 then determines whether the vehicle arrives at the destination (step S112) and,, if Yes, ends the operation.

If No in step S112, the mobile apparatus 52 determines whether the vehicle goes off the area covered by the map that corresponds to the map data received from the server 51 in step S110 and stored in the storage 4 (step S113). If No, the procedure returns to step S108, wherein the mobile apparatus 52 continues route guide along the optimum route.

If Yes in step S113, the procedure repeats step S101 and thereafter. That is, the mobile apparatus 52 again notifies the server 51 of the present position and the destination. Based on these, the server 51 again carries out a route search, and transmits, to the mobile apparatus 52, a newly found optimum route, map data covering the optimum route, and its related information. Thereafter, the mobile apparatus 52 guides the vehicle along the new optimum route by using the new map data.

In FIG. 3B, after transmitting the information to the mobile apparatus 52, the server 51 determines whether to continue the operation (step S114). If No, the server 5 ends the operation. If Yes, the procedure returns to step S104.

In the above described operation of the present system, steps S101 and S102 of FIG. 3A may be executed in reverse order.

The detailed operation of the system, that is, each of steps S101 to S114 shown in FIG. 3, is next described.

Map data and related information stored in the server

In FIG. 1, the map data storage 106 stores the map data comprised of positional information about route nodes, roads, buildings (type and shape), streets, natural objects, place names, altitudes, for example, and their related information such as attributes. Such positional information is stored in two-dimensional coordinate system by latitude and longitude.

The map data varies in form depending on the mobile apparatus 52. For this reason, a plurality of types of the map data are stored. The map data storage 106 receives these plurality of types of the map data externally through the input/output part 109 and the communication line network 122, and always holds the latest map data.

The related information storage 108 stores the related information such as descriptions of the buildings, events held in shops (discount sale), traffic jam, parking lots (locations, fees, and vacancy), events, sightseeing spots, and weather forecast. The related information storage 108 receives such information externally through the input/output part 109 and the communication line circuit 122 at predetermined time intervals or every time the information is updated, and always holds the latest one.

The related information is stored in the related information storage 108. That is, for example, each piece of related information is accompanied by data indicating latitude and longitude in two-dimensional coordinate system. The related information generally has a data form that can be browsed through the Internet.

Detecting the present position (step S102)

The present position detector 2 detects the present position of the vehicle. This detection can be implemented by a so-called GPS (Global Positioning System) receiver, and more accurately by a DGPS (Differential Global Positioning System) receiver.

The detection by such GPS receiver can be further improved by incorporating an acceleration sensor or gyroscopic sensor in the vehicle for sensing the distance or direction traveled. With the sensing results, the present position detected by the GPS receiver can be corrected, and the vehicle can be located even though it is at a place undetectable by the GPS receiver, such as in a tunnel. The detection of the vehicle's present position is carried out at predetermined time intervals (approximately twice to ten times per second). The position detected by the present position detector 2 is sent to the rendering part 8 and the wireless transmitter/receiver 3.

Inputting the destination (step S101)

The operational input part 1 is for the user to enter information composed of the registration identifier, starting point position, destination position, identifier indicating an optimum-route search method, an identifier indicating whether the related information is required. If the starting point position is the present position, the user's input is not required because the present position detected by the present position detector 2 is used. The destination point is positionally specified by a place name, building name, address, telephone number, or other information.

The optimum-route search method identifier indicates which method is to be taken for searching the optimum route to the destination. Available search methods may consider traffic jam, the sights and historic scenes for sightseeing, or minimum time and minimum distance.

The related information identifier indicates whether the information related to the guide route is required. Such related information includes descriptions of the buildings, events in the shops (discount sale), traffic jam, parking lots (locations, fees, and vacancy), events, sightseeing, and weather forecast. The related information also indicates how much details are required (detailed or summarized, for example), and what type of the related information is required.

When using the service for the first time, the user has to also enter registration information. The registration information includes, by way of example only, a name of the user to be registered, address, identifier of a user's machine (form of the map data), information for electronically settling a charge (credit card, for example). Alternatively, such registration information may be sent to a billing management organization through a predetermined communication means such as telephone, facsimile, mail, or electronic mail.

Providing the present position and destination (step S103)

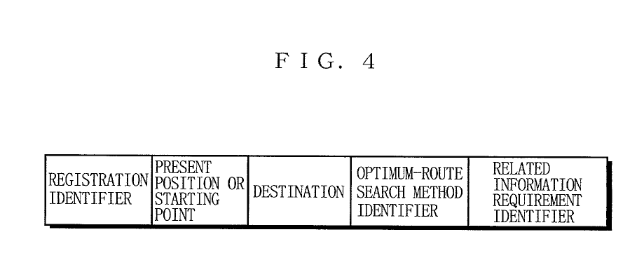

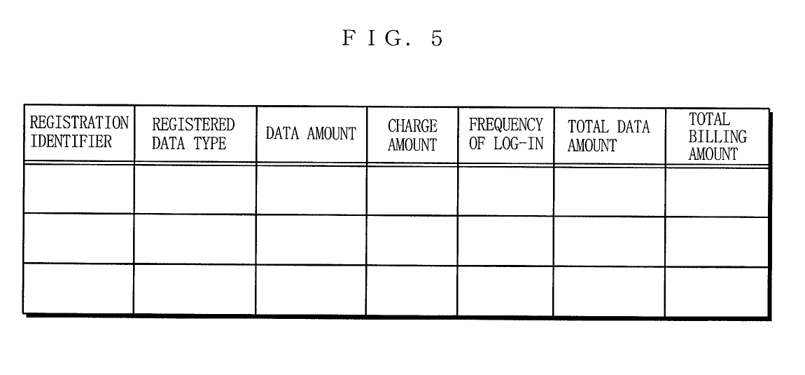

The input information entered through the operational input part 1 is sent out, as a packet having the structure as exemplarily shown in FIG. 4, from the wireless transmitter/receiver 2 to the server 51 side. In FIG. 4, the packet is structured by the registration identifier, present position or starting point position, destination position, optimum-route search method identifier, and related information requirement identifier.

Receiving the present position and destination (step S104)

In the server 51, the wireless transmitter/receiver 101 receives the input information transmitted from the wireless transmitter/receiver 3 in the above stated manner. Such transmission and receiving can be implemented by a wireless communication technique used in so-called packet communications. The wireless transmitters/receivers 3 and 101 may be implemented by cell phones.

Registration check table held by the server

In the server 51, the registration check part 102 holds the registration check table having a form as shown in FIG. 5. In FIG. 5, recorded in the registration check table for each registered member are the registration identifier, registered data form, data amount, charge amount, frequency of log-in, total data amount, total billing amount.

The registration identifier is information for identifying each registered user (hereinafter, registered member).

The registered data form indicates a data form of the information to be used by the registered member. Since the usable data form may vary according to the type of the mobile apparatus 52, the data form suitable for the user's machine is registered in advance in the server 51 side, and the information in such data form is transmitted.

The data amount indicates the amount of information provided to the registered member in the previous service. The charge amount indicates the amount of charge for the information transmitted to the registered member in the previous service. The charge amount is calculated based on the data amount and billing information (will described below). The frequency of log-in indicates how many times or how long the registered member has logged in to the server 51, represented by the number of times of log-in or a log-in time period.

The total data amount indicates the total amount of information provided to the registered member until now. The total billing amount indicates the total amount of billing for the information transmitted to the registered member until now.

Checking whether the user is a registered member (step S105)

Referring back to FIG. 1, the registration check part 102 checks, against the registration check list of FIG. 5, the registration identifier included in the input information received by the wireless transmitter/receiver 101. If the check result shows that the user is a registered member, that is, if the registration identifier included in the input information is recorded in the list, the registration check part 102 determines that the service is to be provided. Then, the registration check part 102 retrieves the registered data form for the registered member, and notifies the map data selector 105 of the data form. On the other hand, if the user is not a registered member, the registration check part 102 notifies the user through the wireless transmitter/receiver 101 that the service is not available. If the user uses the system for the first time, a new registration identifier is assigned to the user, and added to the registration check list together with a registered data form for the user.

Then, if it is determined after checking against the registration check list that the service is to be provided, a route search is carried out.

Searching for the optimum route (step S106)

Of the input information received by the wireless transmitter/receiver 101, the starting point position (present position), destination position, and optimum-route search method identifier are provided to the route search part 104, and the related information requirement identifier is provided to the billing part 103 and the map data selector 105.

When receiving the starting point position (present position), destination position, and optimum-route search method identifier, the route search part 104 first reads the map data stored in the map data storage 106 for specifying the starting point position and destination position. In other words, the route search part 104 specifies the absolute positions of the starting point and the destination by latitude and longitude, for example, based on the starting point and destination represented by address, place name, or telephone number. The map data to be used for specifying the positions may be the one dedicated to position specification.

The dedicated map data is fast searchable data such as an address directory, place-name directory, telephone directory. In each such directory, addresses, place names, telephone numbers are registered in relation to the information that can specify absolute positions such as longitude and latitude.

If the absolute positions of the starting point and destination cannot be uniquely specified only by the positional information included in the input information, the following procedure is taken. That is, the route search part 104 first finds a plurality of potential positions based on the positional information included in the input information. Then, the route search part 104 transmits the potential positions to the mobile apparatus 52 side through the wireless transmitter/receiver 101.

In the mobile apparatus 52, the wireless transmitter/receiver 3 receives the potential positions transmitted from the server 51, and sends them to the rendering part 8. The rendering part 8 renders images for the potential positions for display on the display part 9. The user sees the images for the potential positions displayed on the display part 9, determining which position is correct. Then, the user selects the correct position via the operational input part 1.

Once the absolute positions are specified by user's selection among the potential positions, the operational input part 1 provides the specified absolute positions of the starting point and destination to the server 51 side through the wireless transmitter/receiver 3. In the server 51, the wireless transmitter/receiver 101 receives the specified positions, and notifies the route search part 104 of these positions.

Once recognizing the absolute positions, the route search part 104 sends data indicating these absolute positions (longitude and latitude information, for example) to the map data selector 105. Based on the absolute positions provided by the route search part 104 and the registered data form provided in advance by the registration check part 102, the map data selector 105 reads route node information and road information from the map data stored in the map data storage 106. Such route node information and road information cover an area defined by the staring point and destination and have a data form that conforms to the user's registered data form. The map data selector 105 sends the route node information and road information to the route search part 104.

The route search part 104 finds an optimum route based on the route node information and road information read by the map data selector 105.

The above optimum route search is carried out by the Dijkstra's algorithm preferably with weighting. In the Dijkstra's algorithm with weighting, every link composing the route is provided with a weight based on predetermined criteria.

In the Dijkstra's algorithm with weighting, the route search part 104 changes the weight to be provided to every link based on the method indicated by “the optimum-route search method identifier”

If the identifier indicates “route search for sightseeing”, for example, the route search part 104 refers to the sightseeing information stored in the related information storage part 10 for putting a small weight to every link in the vicinity of sightseeing spots. Thus, the route search part 104 can find a route through the vicinity of the sightseeing spots to the destination.

If the identifier indicates “route search in consideration of traffic jam”, the route search part 104 refers to the latest traffic jam information stored in the related information storage 108 for putting a large weight to every link corresponding to a jammed road section. Thus, the route search part 104 can find a route that enables the vehicle to reach the destination by detouring around the jammed road section.

The Dijkstra's algorithm with weighting has been described in Background Art section.

Selecting map data/related information

The optimum route found by the route search part 104 in the above described manner is provided to the map data selector 105 and the transmission data history storage 111. The transmission data history storage 111 stores the optimum route received from the route search part 104 together with a time when the optimum route is received. In other words, the transmission data history storage 111 stores histories of finding the optimum route, that is, when and what route was found as the optimum route.

Based on the optimum route provided by the route search part 104 and the registered data form provided in advance by the registration check part 102, the map data selector 105 reads wide-area map data (more reduced map data) and detailed map data (less reduced map data) from the map data stored in the map data storage 106. The wide-area map data has a data form that conforms to the user's registered data form, and covers the optimum route. The detailed map data also has a data form that conforms to the user's registered data form, and covers the vicinity of the optimum route.

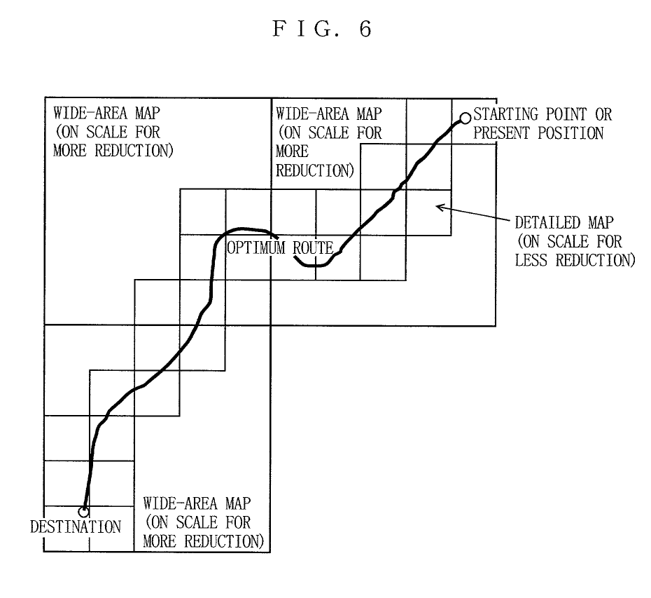

One example of the wide-area maps and the detailed maps each selectively read by the map data selector 105 is shown in FIG. 6. In the example of FIG. 5, the optimum route from the starting point to the destination extends over three wide-area maps. Therefore, these three maps are read.

Each wide-area map is divided into 25 (=5×5) small areas. Of these 25 small areas, the map data selector 105 selects the one that covers an area satisfying that the distance from the optimum route is within a threshold. In this example, the number of the small areas to be selected is twelve, and only the data for twelve maps that correspond to these twelve small areas are read from the map data storage 106. In other words, the map data selector 105 determines that the detailed map data that covers the area away from the optimum route is not required, and does not read such map data.

The map data selector 105 also reads the information related to the read map data if the related information requirement identifier included in the input information indicates positive. That is, the map data selector 105 determines that the information not related to the read map data is not required, and does not read such information. The read map data (including the optimum route) and related information in the above described manner are provided to the transmission data compression part 107.

Billing (step S108)

The map data selector 105 also notifies the registration check part 102 and the billing part 103 of the amount of map data read from the map data storage 106 and the type and amount of the related information. The billing part 103 stores a list including a predetermined price schedule. Based on the price list, the billing part 103 calculates the amount of charge for the information transmitted to the mobile apparatus 52.

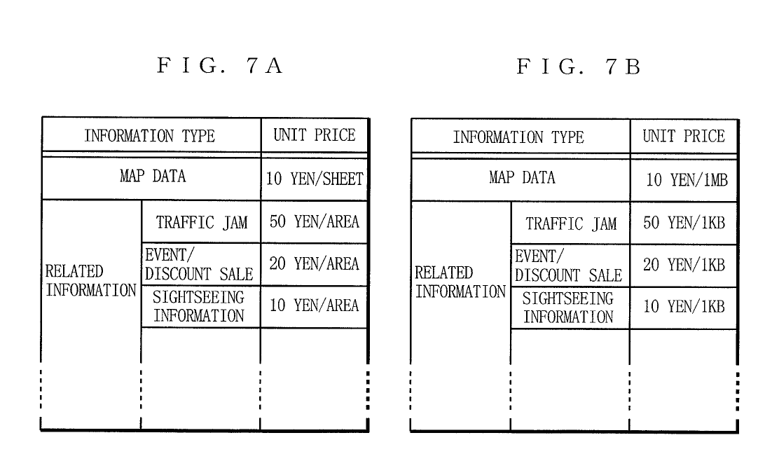

FIGS. 7A and 7B are diagrams each showing a specific example of the price list stored in the billing part 103. Described in the price list of FIG. 7A are a unit price per sheet for the map data (10 yen per sheet, for example) and a unit price per area that corresponds to one sheet of map data (“50 yen per area” for the traffic jam information, “20 yen per area” for the event/discount sale information, and “10 yen per area” for the sightseeing information, for example).

Described in the price list of FIG. 7B are a unit price per Mbyte for the map data (“10 yen per Mbyte, for example) and a unit price per Kbyte for the related information (“50 yen per Kbyte” for the traffic jam information, “20 yen per Kbyte” for the event/discount sale information, and “10 yen per Kbyte” for the sightseeing information, for example).

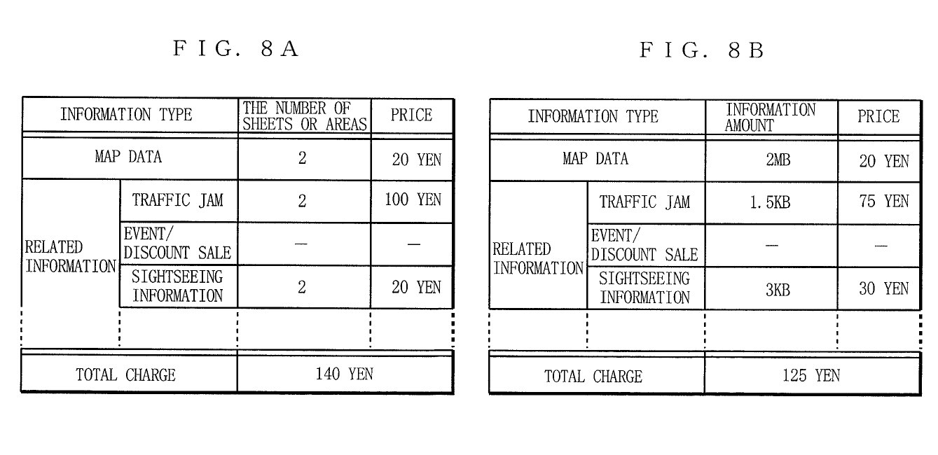

FIG. 8A is a diagram showing a specific example of the amount of charge (billing information) calculated according to the price list shown in FIG. 7A. FIG. 8B is a diagram showing another specific example of the amount of charge (billing information) calculated according to the price list in FIG. 7B.

According to the area-based price list of FIG. 7A, the amount of charge can be easily calculated. However, the amount of related information varies depending on the area. For example, the number of roads and shops greatly varies depending on whether the area is urban or suburban. Therefore, the user has to pay the same amount of charge irrespectively of the amount of related information received.

On the other hand, if the amount of charge is calculated according to the Kbyte-based price list of FIG. 7B, the user pays the charge in accordance with the amount of related information actually received. However, the amount of information has to be strictly managed, and therefore charge calculation becomes burdensome.

The billing part 103 notifies the registration check part 102 of the calculated amount of charge. Based on the data amount provided by the map data selector 105 and the amount of charge provided by the billing part 103, the registration check part 102 updates the data amount, charge amount, frequency of log-in, total data amount, and total billing amount in the registration check list. Then, the registration check part 102 provides the updated contents of the list to the wireless transmitter/receiver 101.

Transmitting the optimum route, map data, and related information (step S109)

The transmission data compression part 107 compresses the map data (including the optimum route) and related information received from the map data selector 105. This compression process can be executed by using a method generally known such as run-length encoding. The transmission data compression part 107 transmits the compressed data to the wireless transmitter/receiver 101.

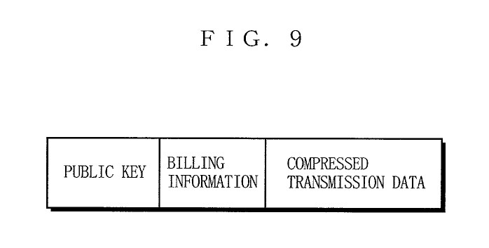

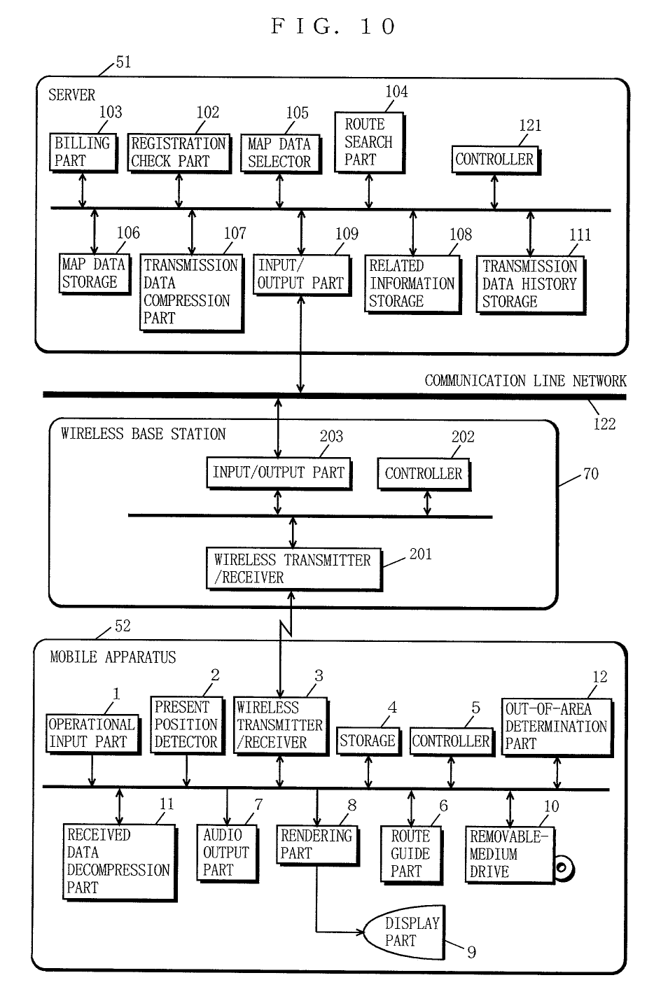

The wireless transmitter/receiver 101 transmits, to the wireless transmitter/receiver 3 of the mobile apparatus 52, the updated contents (billing information) of the registration check list provided by the billing part 103 and the compressed data received from the transmission data compression part 107. The billing information and the compressed data are transmitted as a packet having the structure as shown in FIG. 9, for example.

The packet shown in FIG. 9 is structured by a public key, the billing information, and the compressed data. The billing information, and the compressed data are encrypted with the attached public key for preventing unauthorized use. Well-known public-key encryption systems include the one based on the elliptic curve theory, and the one by factoring. Although the public key encryption system is used in this example, this is not restrictive, and any of various encryption systems can be taken.

The wireless transmitter/receiver 101 may divide the data into regions, and sequentially transmit these regions in the order of closeness to the starting point. This is effective for a long route, that is, a large data amount.

Receiving the optimum route, map data, and related information (step S110)

The wireless transmitter/receiver 3 receives the packet transmitted from the wireless transmitter/receiver 101, and provides the rendering part 8 with the update contents (billing information) of the registration check list included in the received packet. Based on the provided billing information, the rendering part 8 generates images indicating the transmission data amount, charge amount, and other information for display on the display part 9. The compressed data included in the received packet is decompressed by the received data decompression part 11. The decompressed data is stored in storage 4. For displaying the billing information and decompressing the data, a decryption key for decrypting the public-key encryption has to be held by the user.

Displaying route guide and related information (step S111)

Route guide in the mobile apparatus 52 side is carried out as follows. Now, the storage 4 stores the decompressed data indicating the wide-area map including the optimum route and the detailed map covering the vicinity of the optimum route. First, the present position detector 2 detects the present position of the vehicle, and notifies the rendering part 8 of the detected position. Also, the user selects a scale through the operational input part 1, and notified the rendering part 8 of the selected scale.

The rendering part 8 reads, from the storage 4, the map data that has the scale equal to the selected scale received from the operational input part 1 and covers the position (the present position of the vehicle) received from the present position detector 2. The read map data indicates a wide-area map if a scale for more reduction is selected, and a detailed map if a scale for less reduction is selected. The optimum route and the symbol indicating the present position of the vehicle are overlaid on the map for generating an image, and the generated image is displayed on the display part 9.

The mobile apparatus 52 can also perform route guide by voice, as a conventional navigation system can do. In a case where the vehicle goes off the optimum route, the route guide part 6 finds a route between the present position and an appropriate point on the optimum route (for example, the point closest to the present position), and guides the vehicle to return it to the optimum route through the found route. In this case, the route guide part 6 may newly find the optimum route from the present position to the destination. Also in this case, route guide may be carried out only with the wide-area maps in certain circumstances.

Map display may be carried out not only by a two-dimensional display technique but also a three-dimensional computer graphics technique allowing views such as 3D bird's eye views and views of multilevel intersections. In such 3D display, the rendering part 8 requires additional functions such as perspective transformation, luminance calculation, mapping, and buffering.

Furthermore, if any related information stored in the storage 4 is of type that can be overlaid on the map, the rendering part 8 renders images by overlaying the related information for display on the display part 9. Such type of related information includes traffic jam information, buildings near the route, and information about sightseeing spots. Overlaying the related information on the map is possible because each piece of related information is provided with latitude and longitude information, and therefore the related information can be positionally linked to the map data.

On the other hand, if the related information is text data such as description or image data such as a diagram, images are rendered separately from the map, and then displayed on the display part 9. If the related information is accompanied by audio data, audio is outputted through the audio output part 7.

Reusing received information (not shown)

After the route guide is thus carried out, the removable-medium drive 10 saves the data stored in the storage 4 into a writable storage medium. The saved data can be read as required for reuse in the next route guide. In this case, when the starting point position (present position ) and destination are inputted through the operational input part 1, whether the data saved into the storage medium can be reused for a route guide is determined by the route guide part 6.

If Yes, the route guide part 6 notifies the user through the display part 9 that the data in the storage medium can be used for the route guide, and also notifies him/her of a saving date.

On the other hand, If the route guide 6 determines that the saved data cannot be used or if the user determines based on the displayed saving date that a new route search has to be made because the saved date is too old, the route guide part 6 transmits the presently inputted starting point and destination to the server 51 side. The server 51 side carries out a new route search through the same procedure described above based on the received starting point and destination, and then transmits new data (optimum route, map data, and related information) to the mobile apparatus 52 side. The mobile apparatus 52 side carries out route guide by using the data newly received from the server 51.

Determining whether the vehicle has arrived at the destination (step S112)

The present position detector 2 detects the present position of the vehicle. The route guide part 6 compares the detected present position with the destination position. Thus, whether the vehicle has arrived at the destination is determined.

Determining whether the vehicle is out of the area covered by the stored data (step S113)

If No in step S112, that is, if the vehicle has not yet arrived at the destination, the out-of-area determination part 12 refers to the present position detected in step S112 and the area covered by the map data received and stored in step S110 to determine whether the vehicle is out of the area, that is, whether the present position of the vehicle is out of the area covered by the map data stored in the storage 4.

If Yes in step S113, that is, if the vehicle substantially goes off the optimum route to the outside of the area covered by the map data stored in the storage 4, the rendering part 8 cannot read the map data from the storage 4. Therefore, the rendering part 8 generates an image indicating that read is disabled for display on the display part 9. In this case, the user has to go without guide until the vehicle returns to the area covered by the map data stored in the storage 4. To get around this problem, the user may ask the server 51 through the operational input part 1 to carry out an optimum-route search again for receiving the map data required for route guide.

If No in step S113, on the other hand, the route guide part 6 carries out route guide by using the map data stored in the storage 4.

Settling the bill (not shown)

The bill is electronically settled by a credit card, debit card, or the like simultaneously when the service is used, based on the amount of charge managed in the registration check list. Alternatively, the bill is electronically settled by a credit card, debit card, or the like at a predetermined date, based on the total amount of use managed in the registration check list.

Such electronic settlement is carried out by a host computer of a financial institution connected to the communication line network 122, for example. Alternatively, the bill may be settled by the user receiving the bill and going to a financial institution or the like to pay the bill by cash.

At bill settlement, a discount may be given to the user according to the frequency of log-in, total data amount, and total billing amount managed in the registration check list. For one example, in order to entice new users, a special discount is given to them until they log in for a predetermined time For another example, in order to promote sales, a special discount is given to users whose frequency of log-in, total data amount, and/or total billing amount exceeds a predetermined threshold.

In the present embodiment, the server 51 searches for the optimum route and provides the search results and map data, together with the related information. Alternatively, the server 51 may provide only the related information. In this case, the mobile apparatus 52 transmits to the server 51 the packet shown in FIG. 4 with “no route search” as the optimum-route search method identifier. The server 51 does not perform route search and other processing associated with the map data, and transmits only the related information to the mobile apparatus 52.

(Second embodiment)

Hereinafter, an interactive navigation system according to a second embodiment of the present invention is described with reference to the drawings. Note that the same components as those in the first embodiment are provided with the same reference numerals.

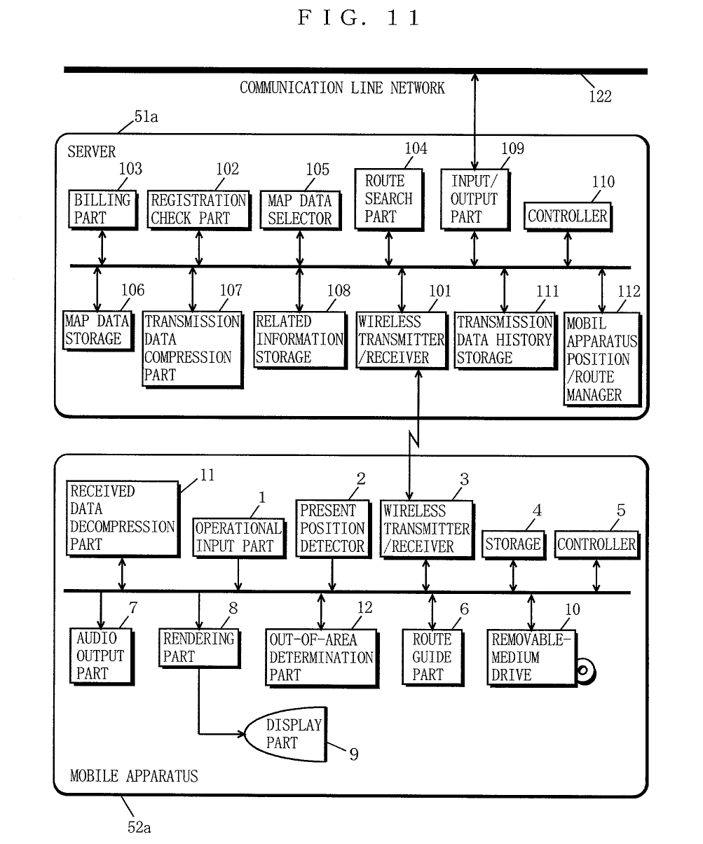

FIG. 10 is a block diagram showing the structure of the interactive navigation system according to the second embodiment of the present invention. In FIG. 10, the system includes the server 51, a wireless base station 70, and the mobile apparatus 52. The mobile apparatus 52 includes the operational input part 1, the present position detector 2, the wireless transmitter/receiver 3, the storage 4, the controller 5, the route guide part 6, the audio output part 7, the rendering part 8, the display part 9, the removable-medium drive 10, and the received data decompression part 11.

The server 51 includes the wireless transmitter/receiver 101, the registration check part 102, the billing part 103, the route search part 104, the map data selector 105, the map data storage 106, the transmission data compression part 107, the related information storage 108, the input/output part 109, the controller 110, and the transmission data history storage 111.

The wireless base station 70 includes a wireless transmitter/receiver 201, a controller 202, and an input/output part 203.

The server 51 is connected to the wireless base station 70 through the communication line network 122. The mobile apparatus 52 and the server 51 can interactively and wirelessly communicate with each other through the wireless base station 70. The server 51 can further communicate, also through the communication line network 122, with the outside such as a host computer in a traffic control center or in a financial institution (not shown).

In other words, the server 51 in the first embodiment wirelessly communicates with the mobile apparatus 52 directly, while the server 51 in the second embodiment does through the wireless base station 70. The wireless transmitter/receiver 201 in the wireless base station 70 has higher output power and sensitivity, and therefore service can be available in a wider area.

The communications between the mobile apparatus 52 and the server 51 is carried out as follows. For data transmission from the mobile apparatus 52 to the server 51, data sent out from the wireless transmitter/receiver 3 of the mobile apparatus 51 is first received by the wireless transmitter/receiver 201 of the wireless base station 70. The data then goes through the input/output part 203, the communication line network 122, and the input/output part 109 to the controller 110 of the server 51.

On the other hand, for data transmission from the server 51 to the mobile apparatus 52, data is transferred from the input/output part 109 of the server 51 through the communication line circuit 122 to the input/output part 203 of the wireless base station 70. The data then is sent out from the wireless transmitter/receiver 201, and then received by the wireless transmitter/receiver 3 of the mobile apparatus 52.

The interactive navigation system of the present embodiment is similar in operation to that of the first embodiment except for the above described communications between the mobile apparatus 52 and the server 51. Therefore, detailed description of the operation is omitted.

(Third embodiment)

Hereinafter, an interactive navigation system according to a third embodiment is described with reference to the drawings. Note that the same components as those in the first embodiment are provided with the same reference numerals.

FIG. 11 is a block diagram showing the structure of the interactive navigation system according to the third embodiment of the present invention. In FIG. 11, the system includes a server 51a and mobile apparatuses 52a. Of these mobile apparatuses 52a, the one for which the server 51a is going to carry out a route search is hereinafter called a target mobile apparatus 52a in order to be distinguishable from the others, and the others are called non-target mobile apparatuses 52a. Note that such distinction is not fixed: one mobile apparatus can be regarded as the target mobile apparatus 52a some time, and the non-target mobile apparatus 52a other time.

The mobile apparatus 52a includes the operational input part 1, the present position detector 2, the wireless transmitter/receiver 3, the storage 4, the controller 5, the route guide part 6, the audio output part 7, the rendering part 8, the display part 9, the removable-medium drive 10, and the received data decompression part 11.

The server 51a includes the wireless transmitter/receiver 101, the registration check part 102, the billing part 103, a route search part 104a, the map data selector 105, the map data storage 106, the transmission data compression part 107, the related information storage 108, the input/output part 109, the controller 110, and the transmission data history storage 111, and a mobile apparatus position route manager 112.

The mobile apparatus 52a and the server 51a can interactively and wirelessly communicate with each other. The server 51a can further communicate, through the communication line network 122, with the outside such as a host computer in a traffic control center or in a financial institution (not shown).

That is, the server 51a is structured by further providing the server 51 of the first embodiment with the mobile apparatus position/route manager 112 and the route search part 104a in stead of the route search part 104.

The hardware structure of the system is similar to that in the first embodiment shown in FIGS. 2A and 2B. However, in FIG. 2B, a program different in part from that in the first embodiment is stored in the ROM 54 of the server 51a side for realizing the functions of the mobile apparatus position/route manager 112 and the route search part 104a, which will be described below.

The operation of the above structured interactive navigation system according to the third embodiment is now briefly described.

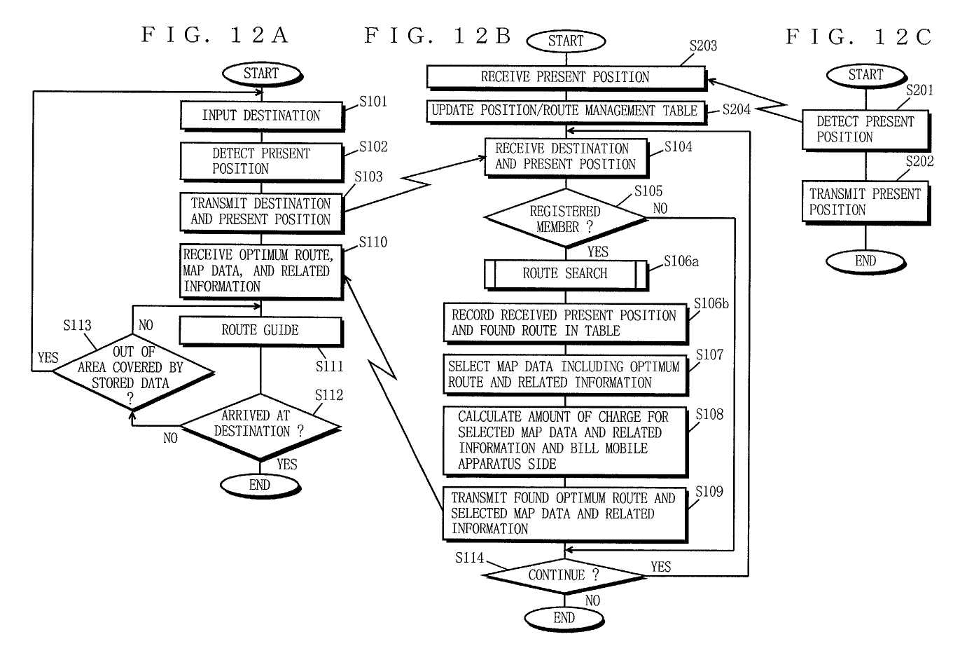

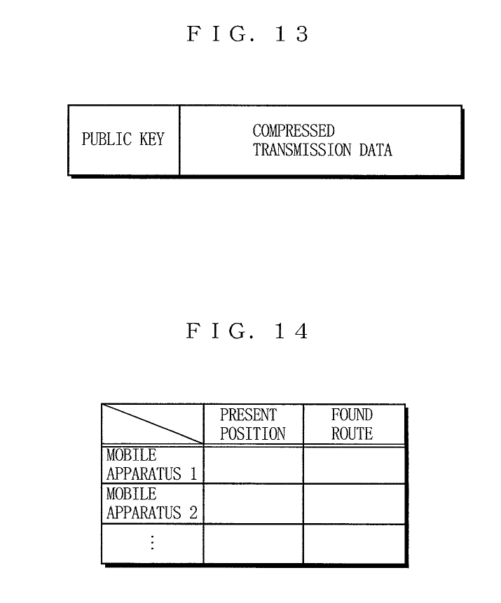

FIG. 12A is a flowchart showing the operation of the target mobile apparatus 52a; FIG. 12B is a flowchart showing the operation of the server 51|a; and FIG. 12C is a flowchart showing the operation of the non-target mobile apparatuses 52a. The operations of the target mobile apparatus 52a and the non-target mobile apparatuses 52a shown in FIGS. 12A and 12C, respectively, are realized by the controller 5 carrying out operations and controlling other components (1 to 4, and 6 to 12). The operation of the server 51 shown in FIG. 12B is realized by the controller 110 carrying out operations and controlling other components (101 to 109, and 111, 112).

In FIG. 12C, each non-target mobile apparatus 52a detects the present position of a vehicle that mounts the non-target mobile apparatus 52a thereon (step S201). The non-target mobile apparatus 52a then sends out the detected present position to the server 51 (step S202). These detection and sending processes are carried out periodically (twice to ten times per second, for example). Alternatively, they may be carried out in response to a request from the server 51a.

In FIG. 12B, the server 51a receives the present position from the non-target mobile apparatus 52a (step S203).

The server 51a stores a position/route management table for managing the present position and optimum route for each mobile apparatus 52a. The optimum route is the one found in step S106a when the mobile apparatus 52a is regarded as the target mobile apparatus 52a. Based on the present position received in step S201, the table is updated (step S204). The mobile apparatus position/route management process in steps S201 and S202 is continuously carried out until a route search request comes from the target mobile apparatus 52a.

The series of operations from steps S101 to S103 and S110 to S113 carried out by the target mobile apparatus 52a shown in FIG. 12A are similar to those shown in FIG. 3A. In FIG. 12B, the series of operations from steps S104, S105, S107 to S109, and S114 carried out by the server 51a in response to the request from the target mobile apparatus 52a are similar to those shown in FIG. 3B, except route search (step S106a) and position/route recording (step S106b). Note that, in the present embodiment, the billing process in step S108 does not have to be required. When the billing process is not carried out, the packet to be transmitted in step S109 has the structure as shown in FIG. 13, wherein billing information is not included.

Similarly to the first embodiment, the server 51a finds, in step S106a, the optimum route with the Dijkstra's algorithm with weighting. The weight to every link is different, however, from that in the first embodiment. That is, the server 51a refers to the mobile apparatus position/route management table for calculating the weight for each link based on the present position and optimum route of the non-target mobile apparatuses 52a.

In step S106b, based on the present position received in step S104 and the optimum route found in step S106a, the server 51a updates the mobile apparatus position/route management table. The procedure then goes to step S107.

The operation of the system has been briefly described above. Note that the steps S101 and S102 of FIG. 3A maybe executed in reverse order.

Next, each of steps S201 to S204 shown in FIG. 12C and steps S106aand S106b shown in FIG. 12B are now described.

Detecting the present position of the non-target mobile apparatuses 52a

In each the non-target mobile apparatus 52a, the present position detector 2 detects the present position of a vehicle that mounts the non-target mobile apparatus 52a thereon . This detection is carried out at predetermined time intervals (twice to ten times per second, for example). The position detected by the present position detector 2 is provided to the rendering part 8 and the wireless transmitter/receiver 3.

Providing the present position (step S202)

The present position detected by the present position detector 2 of the non-target mobile apparatus 52a is sent out from the wireless transmitter/receiver 3 to the server 51a side.

Receiving the present position (step S203)

In the server 51a, the wireless transmitter/receiver 101 receives the present position from the wireless transmitter/receiver 3 of the non-target mobile apparatus 52a.

The mobile apparatus position/route management table held by the server

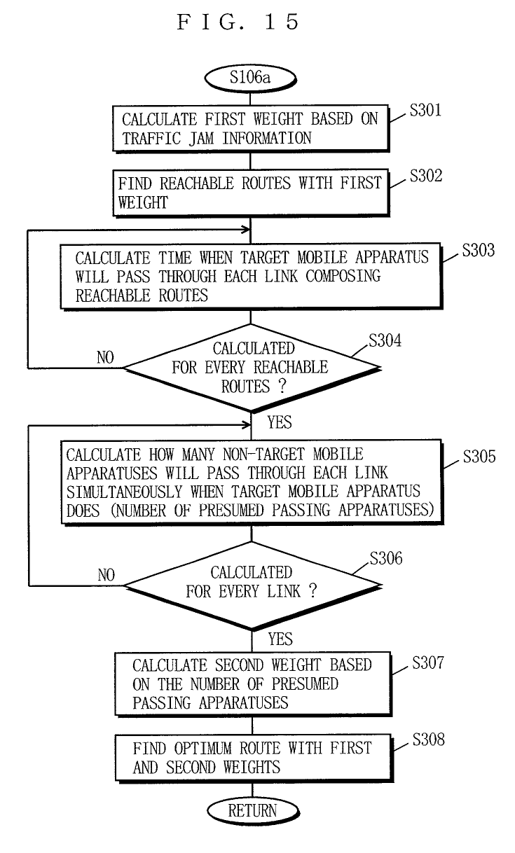

In the server 51, the mobile apparatus position/route manager 112 holds the mobile apparatus position/route table having a form exemplarily shown in FIG. 14. In FIG. 14, recorded in this table for each mobile apparatus 52a are the present position and optimum route.

The present position in this table indicates the latest position of the mobile apparatus 52a received in step S203 by the server 51a. The optimum route is the one found in step S106a when one mobile apparatus 52a is regarded as the target mobile apparatus 52a.

Recording the position of the non-target mobile apparatuses in the table (step S204)

The mobile apparatus position/route manager 112 records the present position of the non-target mobile apparatuses 52a received in step S203. Alternatively, the mobile apparatus position/route manager 112 may update the contents of the table.

Searching for the optimum route (step S106a)

Among the input information received by the wireless transmitter/receiver 101, the starting point position (present position), destination position, and optimum-route search method identifier are sent out to the route search part 104a, while the related information requirement identifier is sent out to the map data selector 105.

Notified of the above information, the route search part 104a first reads the map data stored in the map data storage 106 for specifying the starting point position and destination point. This specifying process is similar to that in the first embodiment, and is not described herein.

After specifying the absolute positions of the starting point and destination, the route search part 104a sends data indicating these absolute positions (longitude and latitude information, for example) to the map data selector 105. Based on the absolute positions provided by the route search part 104a and the registered data form provided in advance by the registration check part 102, the map data selector 105 reads route node information and road information from the map data stored in the map data storage 106. Such route node information and road information cover an area defined by the staring point and destination and have a data form that conforms to the user's registered data form. The map data selector 105 sends the route node information and road information to the route search part 104a.

The route search part 104a calculates the optimum route based on the route node information and road information read by the map data selector 105 and the mobile apparatus position/route management table.

The route search part 104a carries out optimum route search by the Dijkstra's algorithm with weighting. The basic procedure is similar to that in the first embodiment, but different in that the route search part 104a calculates weights provided to the links composing the route according to the following weight calculation method that mainly characterizes the route search of the present embodiment.

If the optimum-route search method identifier indicates “route search in consideration of traffic jam”, the route search part 104a refers to the latest traffic jam information stored in the related information storage 108 for putting an additional weight on each link composing a route jammed at this moment. Such weighting is hereinafter referred to as first weighting. The weight put on each link in the first weighting is so determined as to be increased more with the route jammed more. This process is similar to that in the first embodiment.

In addition, the route search part 104a refers to the present position and optimum route in the mobile apparatus position/route management table for putting an additional weight on each link composing a route the non-target mobile apparatuses 52 will pass through. Such weighting is hereinafter referred to as second weighting. The weight put on each link in the second weighting is so determined as to be increased with the number of non-target mobile apparatuses 52 that will simultaneously pass through that link presumed to be more. This second weighting is a main characteristic of this route search in the present embodiment.

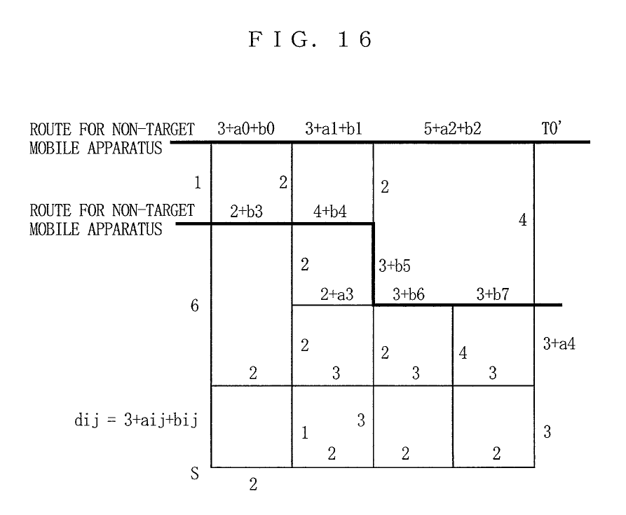

FIG. 15 is a flowchart showing one detailed example of step S106a of FIG. 12B (optimum-route search carried out by the route search part 104a). In FIG. 15, the route search part 104a calculates a weight for each link based on the traffic jam information at this moment externally provided through the communication line network 122 (step S301). Next, the weight calculated in step S301 (hereinafter, first weight) is put on to each link. Then, based on the starting point and destination received in step S104 from the target mobile apparatus 52a, a plurality of reachable routes each positionally connecting the starting point and the destination are found (step S302). Here, a predetermined number (ten, for example) of routes are found as the reachable routes in the order of time taken for the target mobile apparatus 52a to reach the destination, the minimum first.

Next, the route search part 104a calculates, for each of the reachable routes found in step S302, a time when the target mobile apparatus 52a will pass through each link composing the route at predetermined speed such as legal speed (step S303). Then, the route search part 104a determines whether the time are calculated for every reachable route (step S304). If No in step S304, the procedure returns to step S303, and the route search part 104a calculates, for each remaining reachable route, the time when the target mobile apparatus 52a will pass through each link.

If Yes in step S304, the route search part 104a calculates, for one of the links composing the route for which the time has been calculated in step S303, how many non-target mobile apparatuses 52a will pass through the link at predetermined speed such as legal speed simultaneously when the target mobile apparatus 52a passes the link (step S305). This step is carried out based on the present position of every non-target mobile apparatus 52a and the optimum route found for every mobile apparatus 52. Then, the route search part 104a determines whether the number has been calculated for every link (step S306). If No in step S306, the procedure returns to step S305, and the route search part 104a calculates, for each remaining link, how many non-target mobile apparatuses 52a will pass through the link.

If Yes in step S306, the route search part 104a calculates a weight for each link based on the calculation result in step S305 (step S307). That is, the route search part 104a calculates a weight according to the number of non-target mobile apparatuses 52a that will presumably pass simultaneously when the target mobile apparatus 52 will pass. Such number of non-target mobile apparatuses 52 is hereinafter referred to as the number of presumed passing apparatuses. The weight may be calculated, by way of example only, in proportion to the number of presumed passing apparatuses. Specifically, for example, the weight is 0 if the number of presumed passing apparatuses is 0; 0.1 if the number is 1; and 0.2 if the number is 2.

Next, based on the starting point and destination provided in step S104 by the target mobile apparatus 52a, the route search part 104a finds the optimum route connecting the starting point position to the destination position (step S308). The procedure then returns to the flowchart of FIG. 12B.

This is the optimum-route search process in the present embodiment.

Here, the Dijkstra's algorithm with weighting is specifically described, which is unique to the present invention. General optimum-route search with the Dijkstra's algorithm has been described in Background Art section with reference to FIG. 19. Optimum-route search with the Dijkstra's algorithm using the first weight has also been described in Background Art section with reference to FIG. 20.

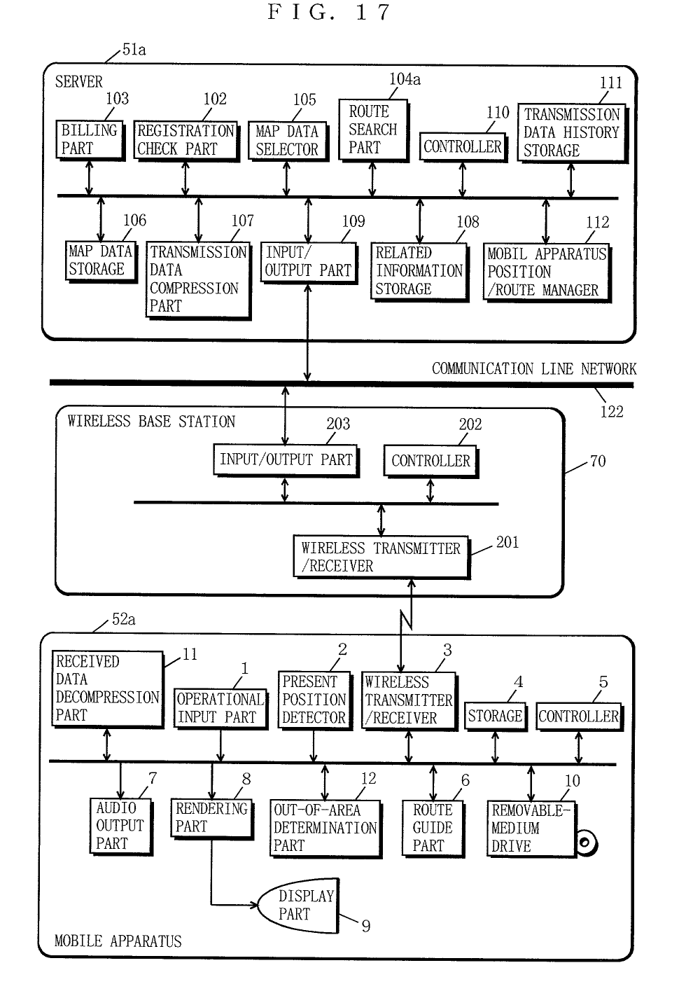

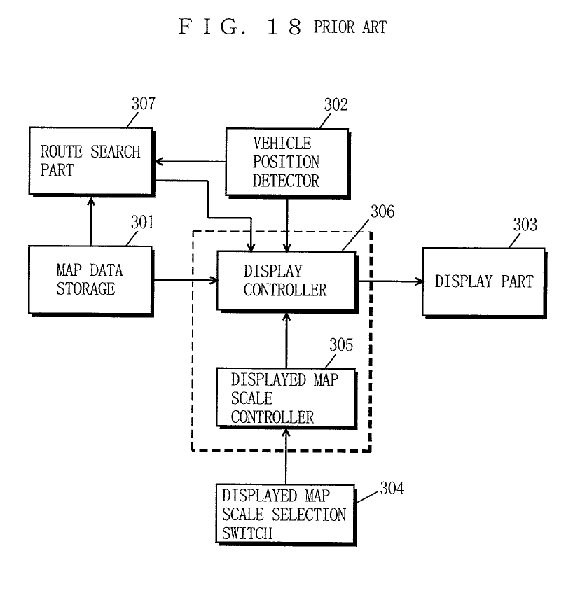

FIG. 16 is a diagram demonstrating optimum-route search with the Dijkstra's algorithm using the first and second weights. In a route graph of FIG. 16, as in the route graph of FIG. 20, some links have a first weight “aij” added to their predetermined link length. The first weight is calculated based on traffic jam at this moment. Also, some links have a second weight “bij” added to their predetermined link length. The second weight is calculated based on the number of presumed passing apparatuses.

In the route graph of FIG. 16, in addition to the first weight calculated based on the traffic jam information externally provided, the second weight “bij” calculated based on the number of presumed passing apparatuses is further provided. The traffic jam information indicates the state of traffic jam for each road section at previous time. On the other hand, the number of presumed passing apparatuses indicates the number of non-mobile apparatuses 52a that will presumably pass through each road section at future time. In other words, route search in the present embodiment is carried out in consideration of future movement of the non-target mobile apparatuses 52a. Therefore, the optimum route is found more accurately compared with the route search based on only the traffic jam at previous time. Thus, the vehicle can be prevented from running into a traffic jam and arriving late.

Recording the target mobile apparatus position and route in the table (step S106b)

The mobile apparatus position/route manager 112 records, for the target mobile apparatus 52a, the present position received in step S104 and the route found in step S106a in the mobile apparatus position/route management table, or updates the contents of that table.

(Fourth embodiment)

Hereinafter, an interactive navigation system according to a fourth embodiment of the present invention is described with reference to the drawings. Note that the same components as those in the first to third embodiments are provided with the same reference numerals.

FIG. 17 is a block diagram showing the structure of the interactive navigation system according to the fourth embodiment of the present invention. In FIG. 17, the system includes the server 51a, the wireless base station 70, and the mobile apparatus 52a. The mobile apparatus 52a includes the operational input part 1, the present position detector 2, the wireless transmitter/receiver 3, the storage 4, the controller 5, the route guide part 6, the audio output part 7, the rendering part 8, the display part 9, the removable-medium drive 10, and the received data decompression part 11.

The server 51a includes the wireless transmitter/receiver 101, the registration check part 102, the billing part 103, the route search part 104a, the map data selector 105, the map data storage 106, the transmission data compression part 107, the related information storage 108, the input/output part 109, the controller 110, and the transmission data history storage 111, and the mobile apparatus position/route manager 112. The wireless base station 70 includes the wireless transmitter/receiver 201, the controller 202, and the input/output part 203.

The server 51a is connected to the wireless base station 70 through the communication line network 122. The mobile apparatus 52a and the server 51a can interactively and wirelessly communicate with each other through the wireless base station 70. The server 51a can further communicate, also through the communication line network 122, with the outside such as a host computer in a traffic control center or in a financial institution (not shown).

In other words, the server 51a in the third embodiment wirelessly communicates with the mobile apparatus 52a directly, while the server 51 in the fourth embodiment does through the wireless base station 70. The wireless transmitter/receiver 201 in the wireless base station 70 has higher output power and sensitivity, and therefore service can be available in a wider area.

The communications between the mobile apparatus 52a and the server 51a is carried out in the manner similar to that of second embodiment. The interactive navigation system of the present embodiment is similar in operation to that of the third embodiment except for the above communications. Therefore, detailed description of the operation is omitted.

While the invention has been described in detail, the foregoing description is in all aspects illustrative and not restrictive. It is understood that numerous other modifications and variations can be devised without departing from the scope of the invention.

What is claimed is:

1. An interactive navigation system that comprises a mobile apparatus and a server and carries out navigation by said mobile apparatus requesting said server to search for a route and said server transmitting a search result to said mobile apparatus,
said mobile apparatus comprising:
input means for inputting at least a destination; and
first transmitter means for transmitting a packet including at least the destination inputted by said input means to said server,
said server comprising:
map data storage means for storing map data;
first receiver means for receiving the packet transmitted by said first transmitter means;
route search means for searching for the route based on the destination included in the packet received by said first receiver means and the map data stored in said map data storage means;
map data selector means for selecting, from among the map data stored in said map data storage means, only map data including the route found by said route search means;
billing means that holds a price list including unit prices for the map data stored in said map data storage means, for calculating an amount of charge for the map data selected by said map data selector means based on the price list, and generating billing information including at least the amount of charge; and
second transmitter means for transmitting, to said mobile apparatus, a packet including at least the route found by said route search means, the map data selected by said map data selector means, and the billing information generated by said billing means.

2. The interactive navigation system according to claim 1, wherein
said mobile apparatus further comprises:
second receiver means for receiving the packet transmitted by said second transmitter means; and
route guide means for carrying out route guide based on the route included in the packet received by said second receiver means and the map data.

3. The interactive navigation system according to claim 1, wherein
said mobile apparatus further comprises present position detector means for detecting a present position of the mobile apparatus,
the packet transmitted by said first transmitter means further includes the present position detected by said present position detector means, and
based on the present position and the destination included in the packet received by said first receiver means and the map data stored in said map data storage means, said route search means searches for the route from the present position and the destination.

4. The interactive navigation system according to claim 1, wherein
a starting point is inputted by said input means,
the packet transmitted by said first transmitter means includes the starting point inputted by said input means, and
based on the starting point and the destination included in the packet received by said first receiver means and the map data stored in said map data storage means, said route search means searches for the route from the starting point and the destination.

5. The interactive navigation system according to claim 1, wherein
said server further comprises related information storage means for storing related information relating to the map data stored in said map data storage means,
the price list held by said billing means includes a unit price for the related information stored in said related information storage means,
said billing means calculates an amount of charge for related information relating to the map data selected by said map data selector means, and adds the calculated amount of charge to said billing information, and
the packet transmitted by said second transmitter means further includes the related information relating to the map data selected by said map data selector means.

6. The interactive navigation system according to claim 5, wherein
said mobile apparatus further comprises presenter means for presenting the related information included in the packet received by said second receiver means.

7. The interactive navigation system according to claim 6, wherein
the related information includes traffic jam information for roads in an area that corresponds to the map data, and
said billing means calculates an amount of charge for the traffic jam information as the amount of charge for related information relating to the map data selected by said map data selector means.

8. The interactive navigation system according to claim 1, wherein
a registration identifier is further inputted by said input means,
the packet transmitted by said first transmitter means further includes the registration identifier inputted by said input means,
said server further comprises registration check means that holds a registration check list including at least all valid registration identifiers, for determining whether the registration identifier included in the packet received by said first receiver means is in the registration check list, and
said route search means carries out the route search only when said registration check means determines that the registration identifier is in the registration check list.

9. The interactive navigation system according to claim 1, wherein
said map data storage means stores a plurality of map data of different forms for use in displaying a same map,
a registered data form is further inputted by said input means,
the packet transmitted by said first transmitter means further includes the registered data form inputted by said input means,
the registration check list held by said registration check means includes the registered data form that corresponds to a registered identifier, and
said map data selector means selects, from among the map data stored in said map data storage means, only map data including the route found by said route search means and complying with a registered data form included in the packet received by said first receiver means.

10. A server that searches for a route in response to a request from a mobile apparatus and transmits the route found by search to said mobile apparatus,
said mobile apparatus comprising:
input means for inputting at least a destination; and
first transmitter means for transmitting a packet including at least the destination inputted by said input means to said server,
said server comprising:
map data storage means for storing map data;
first receiver means for receiving the packet transmitted by said first transmitter means;
route search means for searching for the route based on the destination included in the packet received by said first receiver means and the map data stored in said map data storage means;
map data selector means for selecting, from among the map data stored in said map data storage means, only map data including the route found by said route search means;
billing means that holds a price list including unit prices for the map data stored in said map data storage means, for calculating an amount of charge for the map data selected by said map data selector means based on the price list, and generating billing information including at least the amount of charge; and
second transmitter means for transmitting, to said mobile apparatus, a packet including at least the route found by said route search means, the map data selected by said map data selector means, and the billing information generated by said billing means.

11. An interactive navigation method of carrying out navigation by searching for a route in response to a request from a mobile apparatus and transmitting the route found to said mobile apparatus,
said mobile apparatus comprising:
input means for inputting at least a destination; and
transmitter means for transmitting a packet including at least the destination inputted by said input means to said server,
said method comprising:
a step of storing map data;
a step of receiving the packet transmitted by said transmitter means;
a step of searching for the route based on the destination included in the packet received in said receiving step and the map data stored in said map data storing step;
a step of selecting, from among the map data stored in said map data storing step, only map data including the route found in said route searching step;
a billing step of calculating an amount of charge for the map data selected in said map data selecting step based on a price list including unit prices for the map data stored in said map data storing step, and generating billing information including at least the amount of charge; and
a step of transmitting, to said mobile apparatus, a packet including at least the route found in said route searching step, the map data selected in said map data selecting step, and the billing information generated in said billing step.

12. A program that describes an interactive navigation method of carrying out navigation by searching for a route in response to a request from a mobile apparatus and transmitting the route found to said mobile apparatus,
said mobile apparatus comprising:
input means for inputting at least a destination; and
transmitter means for transmitting a packet including at least the destination inputted by said input means to said server,
said method comprising:
a step of storing map data;
a step of receiving the packet transmitted by said transmitter means;
a step of searching for the route based on the destination included in the packet received in said receiving step and the map data stored in said map data storing step;
a step of selecting, from among the map data stored in said map data storing step, only map data including the route found in said route searching step;
a billing step of calculating an amount of charge for the map data selected in said map data selecting step based on a price list including unit prices for the map data stored in said map data storing step, and generating billing information including at least the amount of charge; and
a step of transmitting, to said mobile apparatus, a packet including at least the route found in said route searching step, the map data selected in said map data selecting step, and the billing information generated in said billing step.

13. An interactive navigation system that comprises a plurality of mobile apparatuses and a server and carries out navigation by one of said mobile apparatuses requesting said server to search for a route and said server transmitting a search result to said mobile apparatus,
each of said mobile apparatuses comprising:
input means for inputting at least a destination;
present position detector means for detecting a present position of the mobile apparatus; and
first transmitter means for transmitting a packet including at least the destination inputted by said input means and/or the present position detected by said present position detector means to said server,
said server comprising:
map data storage means for storing map data;
first receiver means for receiving the packet transmitted by said first transmitter means;
route search means for searching for a route, if the packet received by said first receiver means includes the destination, based on the destination and the map data stored in said map data storage means; and
second transmitter means for transmitting a packet including at least the route found by said route search means to said mobile apparatus, wherein
said route search means
holds a mobile apparatus position/route management table for recording and managing the present position of each of said mobile apparatuses and the route found for each of said mobile apparatuses,
finds a plurality of reachable routes to the destination when the packet received by said first receiver means includes the destination,
sequentially calculates, for each of the found reachable routes, a time when a target mobile apparatus will pass at predetermined speed along the route through each link composing the reachable route,
calculates, for each link, a number of presumed passing apparatuses that indicates how many mobile apparatuses will pass through the link simultaneously when the target mobile apparatus will pass through the link, based on the present position of the mobile apparatuses other than the target mobile apparatus and the route recorded in said mobile apparatus position/route management table,
calculates a weight to be provided to each link based on the number of presumed passing apparatuses calculated for each link, and
searches for the route based on a route graph with each link provided with at least the weight calculated based on the number of presumed passing apparatuses.

14. The interactive navigation system according to claim 13, wherein
said server further comprises input/output means connected to a communication line network, and
said route search means
further externally receives traffic jam information through said input/output means and said communication line network, and calculates a weight to be provided to each link based on the traffic jam information,
finds the plurality of reachable routes based on a route graph with each link provided with the weight calculated based on the traffic jam information, and
searches for the route based on the weight calculated based on the traffic jam information and the weight calculated based on the number of presumed passing apparatuses.

15. An interactive navigation method of carrying out navigation by searching for a route in response to a request from one of a plurality of mobile apparatuses and transmitting the route found to said mobile apparatus,
each of said mobile apparatuses comprising:
input means for inputting at least a destination;
present position detector means for detecting a present position of the mobile apparatus; and
transmitter means for transmitting a packet including at least the destination inputted by said input means and/or the present position detected by said present position detector means to said server,
said method comprising:
a step of storing map data;
a step of receiving the packet transmitted by said transmitter means;
a step of searching for a route, when the packet received in said receiving step includes the destination, based on the destination and the map data stored in said map data storing step; and
a step of transmitting a packet including at least the route found in said route searching step to said mobile apparatus, wherein
in said route searching step,
a mobile apparatus position/route management table is held for recording and managing the present position of each of said mobile apparatuses and the route found for each of said mobile apparatuses, and
said route searching step further comprising:
a step of finding a plurality of reachable routes to the destination if the packet received in said receiving step includes the destination;
a step of sequentially calculating, for each of the found reachable routes, a time when a target mobile apparatus will pass at predetermined speed along the route through each link composing the reachable route;
a step of calculating, for each link, a number of presumed passing apparatuses that indicates how many mobile apparatuses will pass through the link simultaneously when the target mobile apparatus will pass through the link, based on the present position of the mobile apparatuses other than the target mobile apparatus and the route recorded in said mobile apparatus position/route management table;
a step of calculating a weight to be provided to each link based on the number of presumed passing apparatuses calculated for each link; and
a step of searching for the route based on a route graph with each link provided with at least the weight calculated based on the number of presumed passing apparatuses.

16. A program that describes an interactive navigation method of carrying out navigation by searching for a route in response to a request from one of a plurality of mobile apparatuses and transmitting the route found to said mobile apparatus,
each of said mobile apparatuses comprising:
input means for inputting at least a destination;
present position detector means for detecting a present position of the mobile apparatus; and
transmitter means for transmitting a packet including at least the destination inputted by said input means and/or the present position detected by said present position detector means to said server,
said method comprising:
a step of storing map data;
a step of receiving the packet transmitted by said transmitter means;
a step of searching for a route, when the packet received in said receiving step includes the destination, based on the destination and the map data stored in said map data storing step; and
a step of transmitting a packet including at least the route found in said route searching step to said mobile apparatus, wherein
in said route searching step,
a mobile apparatus position/route management table is held for recording and managing the present position of each of said mobile apparatuses and the route found for each of said mobile apparatuses, and
said route searching step further comprising:
a step of finding a plurality of reachable routes to the destination if the packet received in said receiving step includes the destination;
a step of sequentially calculating, for each of the found reachable routes, a time when a target mobile apparatus will pass at predetermined speed along the route through each link composing the reachable route;
a step of calculating, for each link, a number of presumed passing apparatuses that indicates how many mobile apparatuses will pass through the link simultaneously when the target mobile apparatus will pass through the link, based on the present position of the mobile apparatuses other than the target mobile apparatus and the route recorded in said mobile apparatus position/route management table;
a step of calculating a weight to be provided to each link based on the number of presumed passing apparatuses calculated for each link; and
a step of searching for the route based on a route graph with each link provided with at least the weight calculated based on the number of presumed passing apparatuses.
